(19) United States
(12) Patent Application Publication
(10) Pub. No.: US 2016/0364009 A1
(43) Pub. Date: Dec. 15, 2016

(54) GESTURE RECOGNITION FOR WIRELESS AUDIO/VIDEO RECORDING AND COMMUNICATION DEVICES

(71) Applicant: BOT HOME AUTOMATION, INC., Santa Monica, CA (US)

(72) Inventor: Elliott Lemberger, Santa Monica, CA (US)

(21) Appl. No.: 15/246,323

(22) Filed: Aug. 24, 2016

Related U.S. Application Data
(63) Continuation-in-part of application No. 14/334,922, filed on Jul. 18, 2014.
(60) Provisional application No. 61/847,816, filed on Jul. 18, 2013.

(51) Int. Cl. G06F 3/01; G06K 9/00; H04N 7/18

(52) U.S. Cl. CPC G06F 3/017; H04N 7/186; G06K 9/00228; G06K 9/00302

(57) ABSTRACT

A/V recording and communication devices and methods that permit commands to be executed based on gestures recorded by the camera, and which may include automatic identification and data capture (AIDC) and/or computer vision. In one example, the camera receives an input comprising a user-generated gesture. The gesture is interpreted and, if it matches defined gesture information, a command associated with the gesture is executed.

### CROSS-REFERENCE TO RELATED APPLICATIONS

This application is a continuation-in-part of application Ser. No. 14/334,922, filed on Jul. 18, 2014, which claims priority to provisional application Ser. No. 61/847,816, filed on Jul. 18, 2013. The entire contents of the priority applications are hereby incorporated by reference as if fully set forth.

### TECHNICAL FIELD

The present embodiments relate to wireless audio/video (A/V) recording and communication devices, including wireless A/V recording and communication doorbell systems. In particular, the present embodiments relate to improvements in the functionality of wireless A/V recording and communication devices that permit commands to be executed based on gestures recorded by the camera of the A/V recording and communication device.

### BACKGROUND

Home safety is a concern for many homeowners and renters. Those seeking to protect or monitor their homes often wish to have video and audio communications with visitors, for example, those visiting an external door or entryway. Audio/Video (A/V) recording and communication devices, such as doorbells, provide this functionality, and can also aid in crime detection and prevention. For example, audio and/or video captured by an A/V recording and communication device can be uploaded to the cloud and recorded on a remote server. Subsequent review of the A/V footage can aid law enforcement in capturing perpetrators of home burglaries and other crimes. Further, the presence of one or more A/V recording and communication devices on the exterior of a home, such as a doorbell unit at the entrance to the home, acts as a powerful deterrent against would-be burglars.

### SUMMARY

The various embodiments of the present wireless audio/video (A/V) recording and communication devices have several features, no single one of which is solely responsible for their desirable attributes. Without limiting the scope of the present embodiments as expressed by the claims that follow, their more prominent features now will be discussed briefly. After considering this discussion, and particularly after reading the section entitled “Detailed Description,” one will understand how the features of the present embodiments provide the advantages described herein.

One aspect of the present embodiments includes the realization that homeowners, renters, and authorized visitors may wish to use an A/V recording and communication device located at a doorway to do more than monitor visitors. They may, for example, wish to use such devices to gain access to the home (or other structure associated with the A/V recording and communication device), to execute tasks within the home, and/or to notify person(s) within the home of their arrival, among other things. They may further wish to accomplish these tasks without traditional input devices, such as keypads, which many A/V recording and communication devices lack. Even for A/V recording and communication devices that have keypads (or other traditional input devices), these traditional input devices are cumbersome and can be hacked or otherwise compromised. Accordingly, a system that permits commands to be executed based on gestures recorded by the camera of an A/V recording and communication device would be advantageous.

In a first aspect, a method for a wireless audio/video (A/V) recording and communication device, the device including a processor, a wireless communication module, and a camera, is provided, the method comprising the camera receiving an input comprising a user-generated gesture, the user-generated gesture including at least one movement made by a user within the field of view of the camera, the processor processing information about the user-generated gesture and generating an output of interpreted information about the user-generated gesture, the wireless communication module transmitting the interpreted information about the user-generated gesture to a network device, the wireless A/V recording and communication device receiving a command from the network device when the interpreted information about the user-generated gesture matches defined gesture information associated with the command, and the processor executing the command.

In an embodiment of the first aspect, the input further comprises an image of the face of the user.

In another embodiment of the first aspect, the command is to play an audio message containing information relating to the identity of the user within the field of view of the camera.

In another embodiment of the first aspect, the command is based on the identity of the user within the field of view of the camera.

In another embodiment of the first aspect, the command is further based on the identity of at least one person known to be present at a premises associated with the wireless A/V recording and communication device.

In another embodiment of the first aspect, the at least one movement comprises at least one of hand movements or sign language.

In another embodiment of the first aspect, the at least one movement comprises a facial expression.

In another embodiment of the first aspect, the at least one movement comprises displaying a printed key within the field of view of the camera.

In another embodiment of the first aspect, the interpreted information comprises information about relative geometric locations of the user's hand in a plane within the field of view of the camera.

In another embodiment of the first aspect, the command is to unlock a door lock, or to disarm a security system, or to disable a motion detector, or to activate a light.

In another embodiment of the first aspect, the command is to transmit a message to a second user.

In another embodiment of the first aspect, the message includes information about the user within the field of view of the camera.

In another embodiment of the first aspect, the command is to play an audio message.

In another embodiment of the first aspect, the audio message indicates the received command has been executed.

In a second aspect, a method for a network device including a processor and a memory is provided, the method comprising receiving, from a wireless audio/video (A/V) recording and communication device, interpreted information about a user-generated gesture, the user-generated gesture including at least one movement made by a user within the field of view of a camera of the wireless A/V recording and communication device, the processor comparing the interpreted information with defined gesture information stored in the memory, and, when the interpreted information matches the defined gesture information, determining a command associated with the defined gesture information, and transmitting the command to the wireless A/V recording and communication device.

In an embodiment of the second aspect, the input further comprises an image of the face of the user.

In another embodiment of the second aspect, the command is to play an audio message containing information relating to the identity of the user within the field of view of the camera.

In another embodiment of the second aspect, the command is based on the identity of the user within the field of view of the camera.

In another embodiment of the second aspect, the command is further based on the identity of at least one person known to be present at a premises associated with the wireless A/V recording and communication device.

In another embodiment of the second aspect, the at least one movement comprises at least one of hand movements or sign language.

In another embodiment of the second aspect, the at least one movement comprises a facial expression.

In another embodiment of the second aspect, the at least one movement comprises displaying a printed key within the field of view of the camera.

In another embodiment of the second aspect, the interpreted information comprises information about relative geometric locations of the user's hand in a plane within the field of view of the camera.

In another embodiment of the second aspect, the command is to unlock a door lock, or to disarm a security system, or to disable a motion detector, or to activate a light.

In another embodiment of the second aspect, the command is to transmit a message to a second user.

In another embodiment of the second aspect, the message includes information about the user within the field of view of the camera.

In another embodiment of the second aspect, the command is to play an audio message.

In another embodiment of the second aspect, the audio message indicates the received command has been executed.

In a third aspect, a method for a wireless audio/video (A/V) recording and communication device, the device including a processor, a memory, and a camera, is provided, the method comprising the camera receiving an input comprising a user-generated gesture, the user-generated gesture including at least one movement made by a user within the field of view of the camera, the processor processing information about the user-generated gesture and generating interpreted information about the user-generated gesture, the processor comparing the interpreted information about the user-generated gesture with defined gesture information stored in the memory, and, when the interpreted information matches the defined gesture information, determining a command associated with the defined gesture information, and the processor executing the command.

In an embodiment of the third aspect, the input further comprises an image of the face of the user.

In another embodiment of the third aspect, the command is to play an audio message containing information relating to the identity of the user within the field of view of the camera.

In another embodiment of the third aspect, the command is based on the identity of the user within the field of view of the camera.

In another embodiment of the third aspect, the command is further based on the identity of at least one person known to be present at a premises associated with the wireless A/V recording and communication device.

In another embodiment of the third aspect, the at least one movement comprises at least one of hand movements or sign language.

In another embodiment of the third aspect, the at least one movement comprises a facial expression.

In another embodiment of the third aspect, the at least one movement comprises displaying a printed key within the field of view of the camera.

In another embodiment of the third aspect, the interpreted information comprises information about relative geometric locations of the user's hand in a plane within the field of view of the camera.

In another embodiment of the third aspect, the command is to unlock a door lock, or to disarm a security system, or to disable a motion detector, or to activate a light.

In another embodiment of the third aspect, the command is to transmit a message to a second user.

In another embodiment of the third aspect, the message includes information about the user within the field of view of the camera.

In another embodiment of the third aspect, the command is to play an audio message.

In another embodiment of the third aspect, the audio message indicates the received command has been executed.

### BRIEF DESCRIPTION OF THE DRAWINGS

FIG. 1 is a front view of Wireless Communication Doorbell according to an aspect of the present disclosure;

FIG. 2 is a side view of Wireless Communication Doorbell according to an aspect of the present disclosure;

FIG. 3 is an exploded view of Wireless Communication Doorbell according to an aspect of the present disclosure;

FIG. 4 is a back view of Wireless Communication Doorbell without the Mounting Plate according to an aspect of the present disclosure;

FIG. 5 is a front perspective view of Wireless Communication Doorbell and Mounting Plate according to an aspect of the present disclosure;

FIG. 6a is a top view of Wireless Communication Doorbell according to an aspect of the present disclosure;

FIG. 6b is a bottom view of Wireless Communication Doorbell according to an aspect of the present disclosure;

FIG. 7 is a back perspective view of Wireless Communication Doorbell according to an aspect of the present disclosure;

FIG. 8 is a cross sectional view from the side of the Camera Ball Assembly and Wireless Communication Doorbell according to an aspect of the present disclosure;

FIG. 9a is front perspective view of the Camera Ball Assembly and Clear Dome according to an aspect of the present disclosure;

FIG. 9b is a front perspective view of the Camera Ball Assembly coupled to Clear Dome according to an aspect of the present disclosure;

FIG. 10a is a cross sectional view from the side of Camera Assembly within Wireless Communication Doorbell according to an aspect of the present disclosure;

FIG. 10b is a cross sectional view from the side of Camera Assembly within Wireless Communication Doorbell according to an aspect of the present disclosure;

FIG. 11a is a cross sectional view from above of Camera Assembly within Wireless Communication Doorbell according to an aspect of the present disclosure;

FIG. 11b is a cross sectional view from above of Camera Assembly within Wireless Communication Doorbell according to an aspect of the present disclosure;

FIG. 12 is an entity relationship diagram displaying components and multiple devices in communication according to the system and method of present disclosure;

FIG. 13 is a process flow diagram describing the steps involved in connecting Wireless Communication Doorbell 61 to a wireless network according to the system and method of present disclosure;

FIG. 14 is a process flow describing the transmission of data to and from Wireless Communication Device to a Smart Device according to the system and method of present disclosure;

FIG. 15 is a diagram displaying multiple devices in communication according to the system and method of present disclosure;

FIG. 16 is a process flow diagram regarding the use and functions associated with Third Party Doorbell Chime 59 according to an aspect of the present disclosure;

FIG. 17 is a process flow describing the steps involved in performing speech recognition to acknowledge Visitors and route them to the appropriate User;

FIG. 18 is a process flow describing the steps involved in performing facial recognition to acknowledge Visitors and route them to the appropriate User;

FIG. 19 is a flowchart illustrating a process for using a wireless audio/video (A/V) recording and communication device for gesture recognition according to various aspects of the present disclosure;

FIG. 20 is a functional block diagram of a client device on which the present embodiments may be implemented according to various aspects of the present disclosure; and

FIG. 21 is a functional block diagram of a general purpose computer on which the present embodiments may be implemented according to various aspects of the present disclosure.

### DETAILED DESCRIPTION

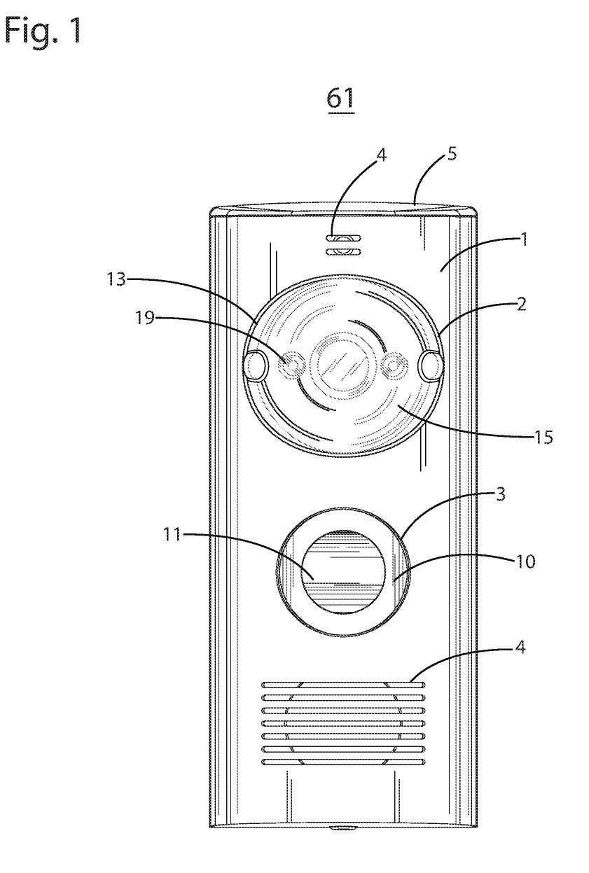

FIG. 1 shows a front view of the Wireless Communication Doorbell 61 according to an aspect of present disclosure. While the present disclosure provides numerous examples of methods and systems including audio/video (A/V) recording and communication doorbells, the present embodiments are equally applicable for A/V recording and communication devices other than doorbells. For example, the present embodiments may include one or more A/V recording and communication security cameras instead of, or in addition to, one or more A/V recording and communication doorbells. An example A/V recording and communication security camera may include substantially all of, or at least some of, the structure and functionality of the doorbells described herein, but without the front button and related components.

The Wireless Communication Doorbell 61 may have Faceplate 1 mounted to Housing 5. Faceplate 1 may be but not limited to brushed aluminum, stainless steel, wood or plastic. Faceplate 1 may contain Perforated Pattern 4 oriented to allow sound to travel in and out of Housing 5 to Microphone 21 and from Speaker 20. Faceplate 1 may be convex and include Button Aperture 3 to allow Button 11 and Light Pipe 10 to mount flush to Faceplate 1. Button 11 and Light Pipe 10 may have convex profiles to match the convex profile of Faceplate 1. Button 11 may be coupled to Housing 5 and may have a stem that protrudes through Housing 5, so Button 11 may make contact with Button Actuator 12 when Button 11 is pressed by Visitor 63. When Button 11 is pressed and makes initial contact with Button Actuator 12, Button Actuator 12 may activate or “wake” components within Wireless Communication Doorbell 61 such as Surface Mount LEDs 9. When Button 11 is pressed, Button Actuator 12 may trigger the activation of Surface Mount LED's 9, mounted to Microcontroller 22 within Housing 5, to illuminate Light Pipe 10. Light Pipe 10 is a transparent ring that encases Button 11. Light Pipe 10 may be any material capable of projecting light, such as transparent plastic, from Surface Mount LEDs 9 out to exterior front face of Wireless Communication Doorbell 61. In one aspect, Faceplate 1 may have multiple Button 11's, each of which may contact a different User 62, in the case of multiple tenant facilities.

Still referencing FIG. 1, Wireless Communication Doorbell 61 may be triggered to wake through Infrared Sensor 42, installed within Housing 5. Infrared Sensor 42 may trigger Camera 18 to record live video or still images of Visitor 63 when Visitor 63 crosses the path of the Infrared Sensor 42. Faceplate Dome Aperture 2, located on the front face of Faceplate 1, allows Clear Dome 13 to protrude from the interior of Housing 5. Clear Dome 13 is a transparent dome shaped component, made of injection molded plastic, glass, or any other material with transparent characteristics. Clear Dome 13 couples to the interior of Housing 5 using screws, fasteners or adhesives, and protrudes through Housing Dome Aperture 6. Camera Ball Assembly 15 may sit within Clear Dome 13 concentrically and share the same origin. Camera Ball Assembly 15 may be smaller in diameter compared to Clear Dome 13, allowing Camera Ball Assembly 15 to rotate and pivot in any direction. Clear Dome 13 protects Camera Ball Assembly 15 against weather elements such as rain and snow. Clear Dome 13 may be transparent to allow for Camera 18, mounted within Camera Ball Assembly 15 to view Visitors 63. Night Vision LEDs 19, also mounted with Camera Ball Assembly 15 may be activated by Microcontroller 22, depending on the time of day, to help illuminate the area in front of Wireless Communication Doorbell 61.

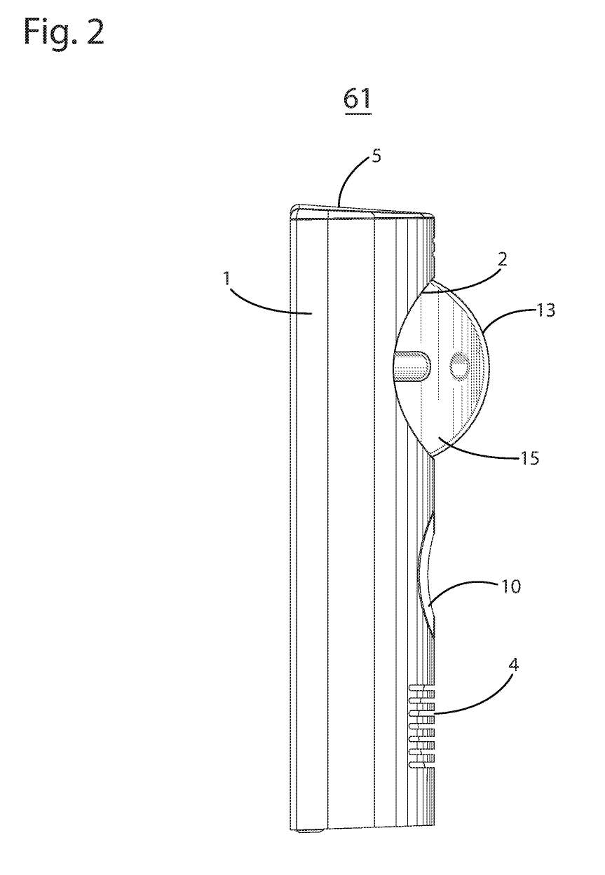

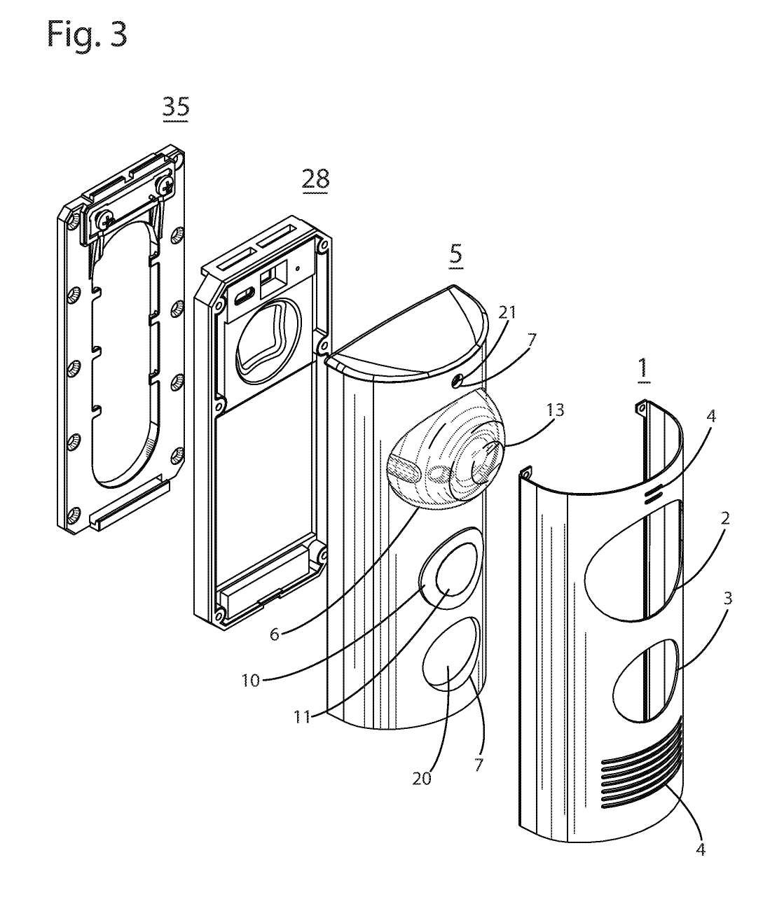

FIG. 2 is a side profile of Wireless Communication Doorbell 61 according to an aspect of the present disclosure. Faceplate 1 may extend around the side of Housing 5, and may be coupled to Housing 5 at the rear of the device. As described in further detail in FIG. 3, Faceplate 1 may be inset into Housing 5 so the top of housing 5 transitions flush into Faceplate 1. Faceplate Dome Aperture 2 allows Camera Assembly 15 and Clear Dome 13 protrude out over Housing 5 and Faceplate 1 to provide maximum visibility. Housing 5 may contain the inset depth required to encase Housing Enclosure 28 and Mounting Plate 35 when all components are coupled together. In this aspect, when Wireless Communication Doorbell 61 is mounted to a mountable surface, Wireless Communication Doorbell 61 sits flush with the surface.

FIG. 3 is an exploded view of Wireless Communication Doorbell 61 according to an aspect of the present disclosure. Faceplate 1 and Housing Enclosure 28 may couple to Housing 5 using fasteners, screws or adhesives. Mounting Plate 35 may be mounted to a mountable surface such as wood, concrete, stucco, brick and vinyl siding using fasteners, screws, or adhesives. The assembly consisting of Faceplate 1, Housing 5 and Housing Enclosure 28 may then be coupled to Mounting Plate 35 using fasteners, screws, or adhesives. As shown in FIG. 2, Housing 5 may contain the inset depth required to encase Housing Enclosure 28 and Mounting Plate 35 when all components are coupled together. In this aspect, when Wireless Communication Doorbell 61 is mounted to a mountable surface, Wireless Communication Doorbell 61 sits flush with the surface.

Still referencing FIG. 3, Faceplate 1 may extend around the side of Housing 5, and may be coupled to Housing 5 at the rear of the device using fasteners, screws or adhesives. Housing 5 may have a protruding lip on the top surface so that Faceplate 1 sits below said protruding lip. Faceplate 1 may contain Perforated Pattern 4 positioned to allow audio to be transmitted via Audio Apertures 7. Housing 5 may have Audio Apertures 7 oriented on the front face of Housing 5 to allow audio to be emitted to and from Speaker 20 and Microphone 21. Housing Dome Aperture 6 may be located on the front face of Housing 5 to allow Clear Dome 13 and Camera Assembly 15 to protrude through Housing 5. Housing Dome Aperture 6 may be positioned on the front face of Housing 5 to line up with Faceplate Dome Aperture 2, to allow Clear Dome 13 and Camera Assembly 15 to protrude through Housing 5. Light Pipe 10 and Button 11 may be mounted to the front face of Housing 5, and may be oriented so it may protrude through Button Aperture 3 on Faceplate 1.

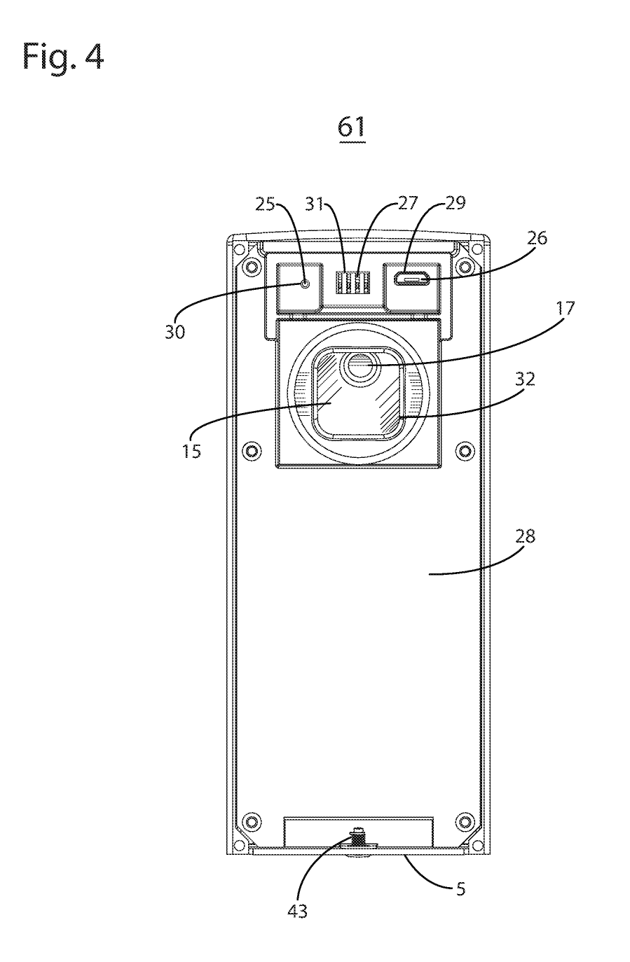

FIG. 4 shows a back view of Wireless Communication Doorbell 61 without Mounting Plate 35, according to an aspect of the present disclosure. In this view Housing Enclosure 28 is set into Housing 5, which protects Wireless Communication Doorbell 61 from weather elements. Housing Enclosure 28 may be coupled to Housing 5 using screws, fasteners, or adhesives.

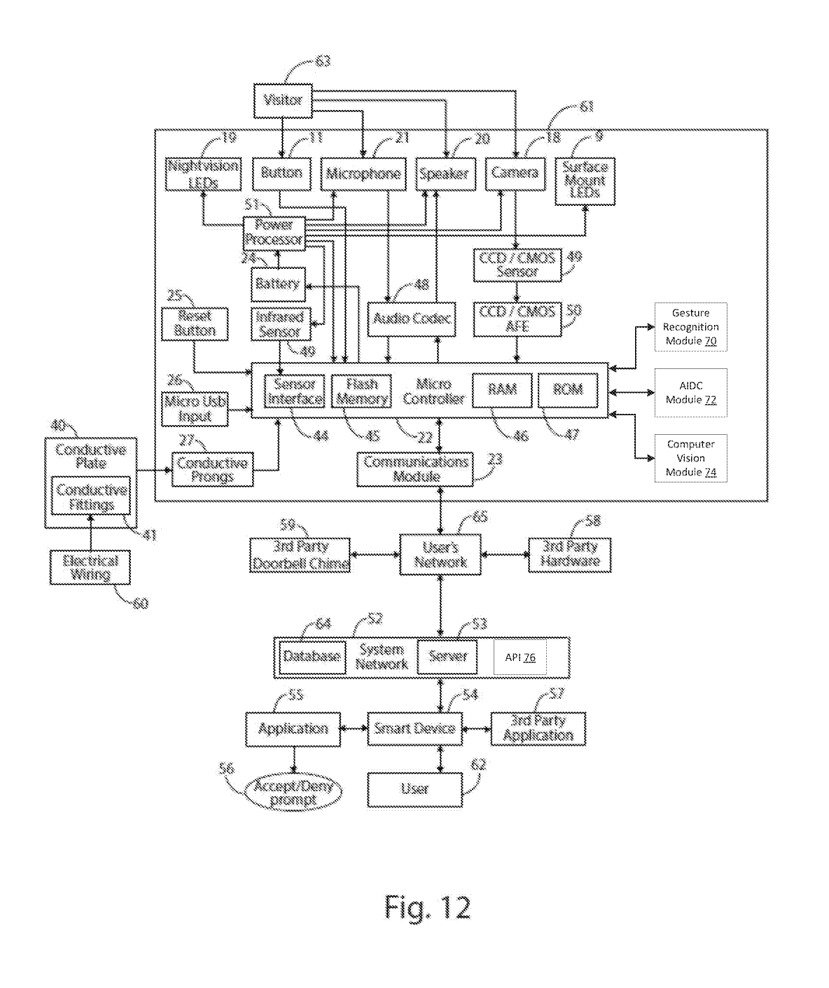

Housing Enclosure 28 contains USB Input Port 29 that provides access to Micro USB Input 26. Micro USB Input 26 is mounted within Housing 5 and charges Battery 24 (not shown in FIG. 3) when a Micro USB connector (not shown) providing power, is plugged into Micro USB Input 26. Micro USB Input 26 may be used to install software onto Flash Memory 45, RAM 46 and ROM 47 (shown in FIG. 12). In one aspect of the present disclosure, Micro USB Input 26 may be but not limited to a USB port, audio jack, ac adapter or any other input capable of transferring power and or data to Wireless Communication Doorbell 61.

Housing Enclosure 28 may provide access to Reset Button 25, located within Housing 5. Reset Button 25 may protrude through Reset Button Port 30, positioned on an exterior face of Housing Enclosure 28. Reset Button 25 may allow User 62 to remove settings associated to User 62, such as User's Network 65 credentials, account settings and unique identifying information such as User 62's ip address. In reference to FIG. 12, Reset Button 25 is connected to Microcontroller 22, located within Housing 5. When Reset Button 25 is pressed by User 62, Microcontroller 22 may be triggered to erase any data stored by User 62 in Flash Memory 45, RAM 46 and ROM 47, such as doorbell audio chimes, audio messages and any other audio data. In this aspect, Microcontroller 22 may disconnect Communications Module 23 from User's Network 65, disabling any wireless communication to and from Wireless Communication Doorbell 61 to Smart Device 54.

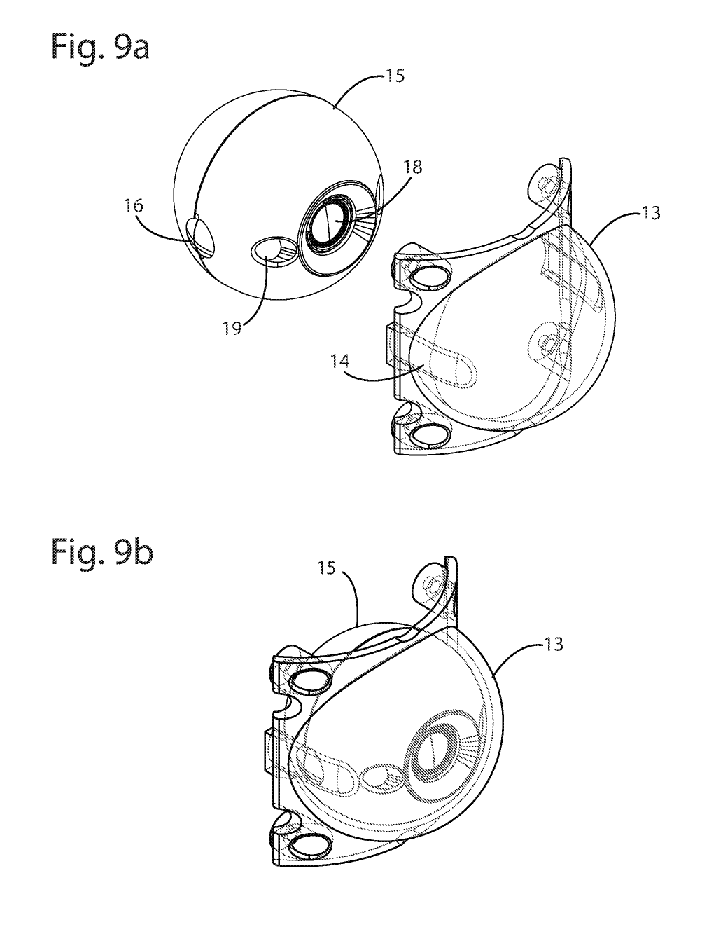

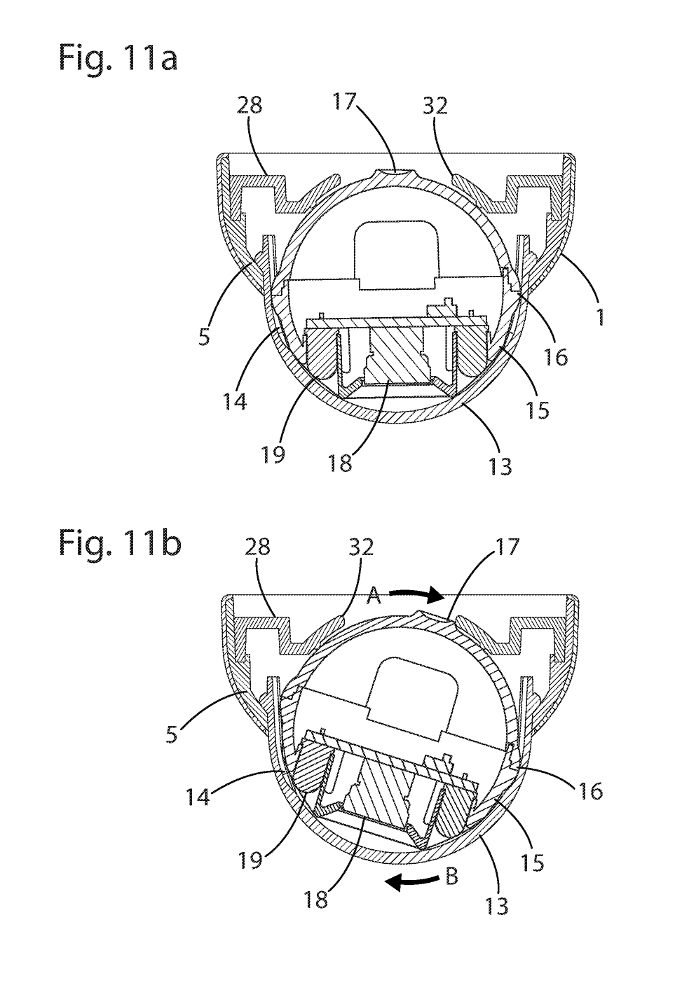

Still referencing FIG. 4, User 62 may be able to manually rotate Camera 18 in the direction of their choice prior to mounting Wireless Communication Doorbell 61 to Mounting Plate 35. Camera 18 is mounted within Camera Ball Assembly 15, which is located within Housing 5. As explained in further detail in FIG. 9 and FIG. 11, when fastened to Housing 5, Housing Enclosure 28 may be arranged against the backside of Camera Assembly 15, mimicking the spherical profile of Camera Assembly 15 to allow for concentric mating. Housing Enclosure 28 may feature Rotation Dimple Access Port 32, which allows User 62 to access Camera Ball Assembly Rotation Dimple 17. Camera Ball Assembly Rotation Dimple 17 is embodied on the back of Camera Ball Assembly 15 and protrudes through Rotation Dimple Access Port 32 to allow access to User 62. Camera Ball Assembly Rotation Dimple 17 is a protruding body that acts like a handle to allow User 62 to rotate Camera Ball Assembly 15 about within Housing 5.

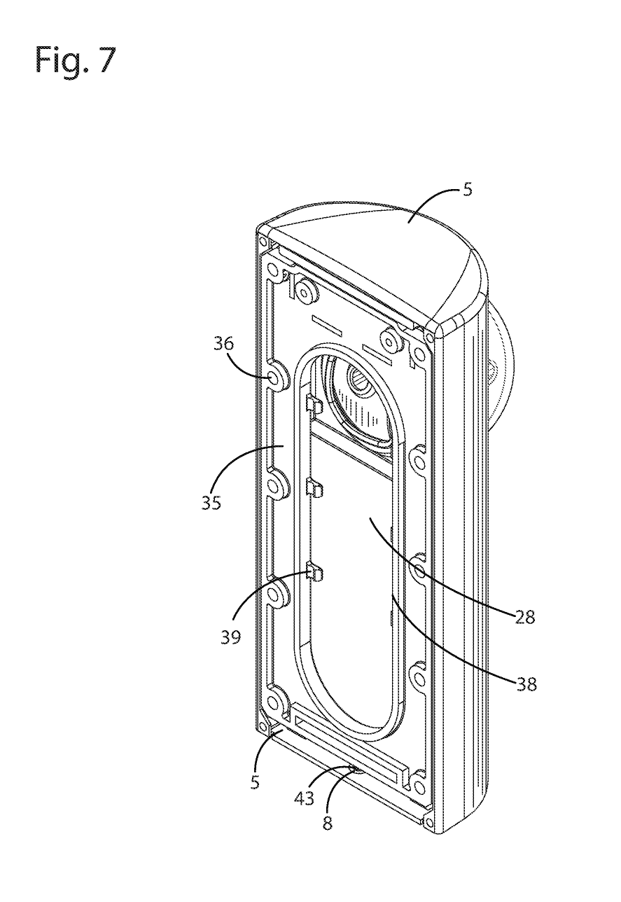

As shown in FIG. 4 through FIG. 7, Wireless Communication Doorbell 61 may be locked in place by Hex Screw 43, which may protrude through Hex Key Port 8 (shown in FIG. 7) positioned on the bottom surface of Housing 5. Hex Screw 43 may protrude through Hex Key Port 8, and wedge Mounting Plate Lip 33 of Mounting Plate 35 (shown in FIG. 7) up against the bottom of Housing Enclosure 28, locking the entire assembly in place. Hex Screw 43 may be any type of fastener capable of securing Mounting Plate 35 to Housing 5 such as but not limited to Allen key bolts, carriage bolts, Phillips head screws, flat head screws, socket screws and Torx screws amongst other screw sets.

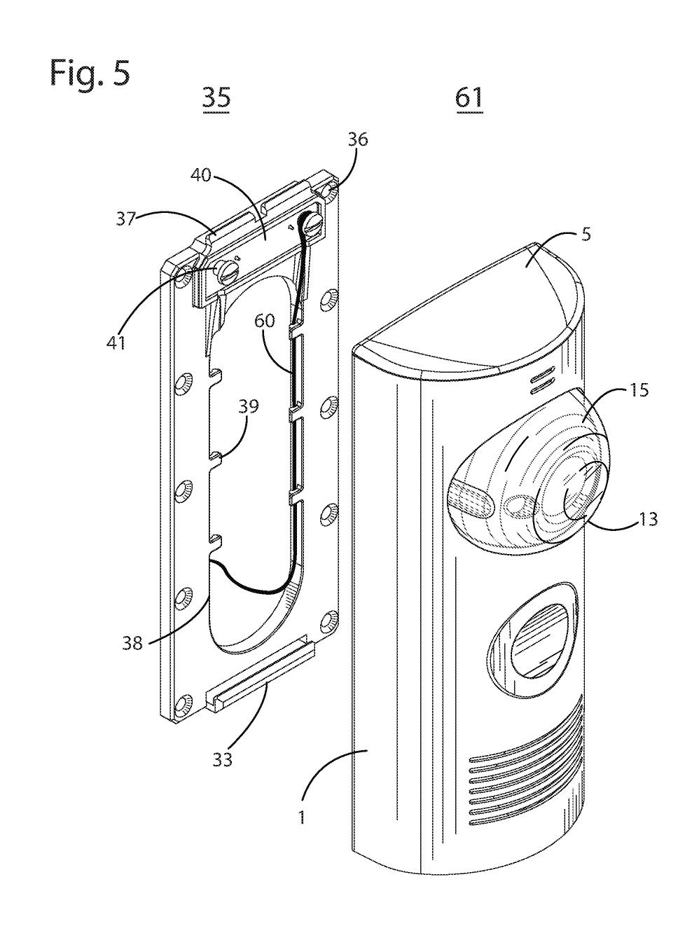

In reference to FIG. 4 and FIG. 5, Wireless Communication Doorbell 61 may be continually powered or charged by hard-wiring Wireless Communication Doorbell 61 directly to Electrical Wiring 60, such as to an AC or DC electrical circuit. In this aspect, Electrical Wiring 60, drawing power from the building that Wireless Communication Doorbell 61 may be mounted to, must be present. This connection is made by sending an electric current from Electrical Wiring 60 to Conductive Prongs 27, located within Housing 5. Conductive Prongs 27 protrude through Conductive Prong Port 31 on Housing Enclosure 28. Conductive Prongs 27 are flexible contacts that may be any material capable of transferring an electric current to Battery 24, when in contact with another conductive surface holding an electric charge.

FIG. 5 shows a front perspective view of Wireless Communication Doorbell 61 and Mounting Plate 35 according to an aspect of the present disclosure. Mounting Plate 35 may be any material capable of supporting Wireless Communication Doorbell 61 such as plastic, metal or wood. Mounting Plate 35 may have multiple Mounting Plate Screw Ports 36, to allow user 62 to securely mount Mounting Plate 35 to an exterior surface using fasteners such as screws, bolts or nails. In a preferred embodiment, the exterior surface that Mounting Plate 35 is mounted to may be adjacent to an exterior door of a building. When Mounting Plate 35 is secured to a surface, Wireless Communication Doorbell 61 may couple to Mounting Plate 61 by inserting Mounting Plate Extrusions 37, positioned atop of Mounting Plate 35, into apertures positioned atop of Housing 5. Mounting Plate Lip 33, positioned on the bottom of Mounting Plate 35 may then be wedged up against the bottom of Housing 5 by pressure applied by the insertion of Hex Screw 43 into Hex Key Port 8.

In reference to FIGS. 4 and 5, if User 62 powers and or charges Wireless Communication Doorbell 61 using Electrical Wiring 60, Wire Access Port 38 may provide an aperture to run Electrical Wiring 60 from mounting surface to connect to Conductive Screws 41. Wire Guides 39, designed as a component of Mounting Plate 35, may protrude on adjacent sides of Wire Access Port 38 and provide a track to guide Electrical Wires 60 up to Conductive Screws 41, which may be secured near the top of Mounting Plate 35. User 62 may wrap Electrical Wires 60 around Conductive Screws 41, transferring electric current to Conductive Fittings 41. Conductive Fittings 41 are fastened to Mounting Plate 35 using screws, fasteners or adhesives. Conductive Fittings 41 may make direct contact with Conductive Plate 40, transferring electric current to Conductive Plate 40. When Wireless Communication Doorbell 61 is mounted to Mounting Plate 35, Conductive Plate 40 makes direct contact with Conductive Prongs 27, which protrudes through Conductive Prong Port located on the back face of Housing Enclosure 28. Direct contact between Conductive Plate 40 and Conductive Prongs 27 may result in the electric current derived from Electrical Wiring 60 being delivered to Conductive Prongs 27, which may provide electricity to charge or power Wireless Communication Doorbell 61.

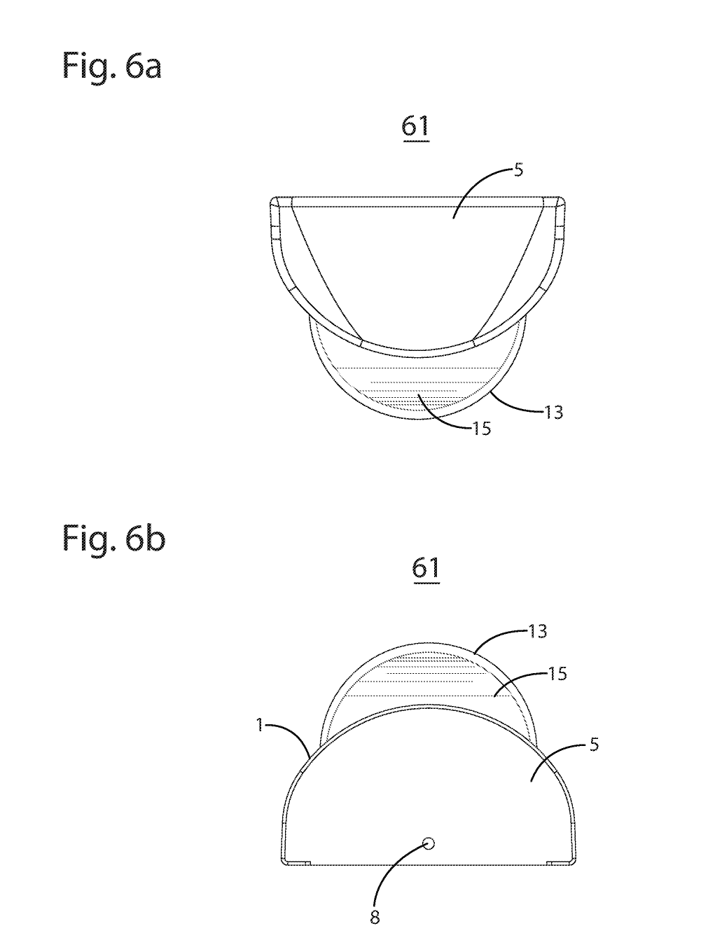

FIG. 6a shows a top view of Wireless Communication Doorbell 61 according to an aspect of present disclosure. As described above in reference to FIG. 1, Housing 5 and Faceplate 1 may have a convex shape. Housing 5 is not limited to this profile, as all components described herein may be arranged within housings with other profiles, such as concave or flat. Housing 5 may have a protruding lip on the top surface so that Faceplate 1 sits below said protruding lip. In one aspect of the present disclosure, Faceplate 1 may be positioned to rest above Housing 5, as so the transition from housing 5 to Faceplate is not flush. The lip created may prevent water or other weather elements from flowing over Faceplate 1. In this aspect, Housing 5 may contain an inset trough, positioned atop Housing 5, to channel water flow around the sides of Wireless Communication Doorbell 61.

FIG. 6b shows a bottom view of Wireless Communication Doorbell 61 according to an aspect of present disclosure. In this view, the bottom of the Wireless Communication Doorbell 50 features Hex Key Port 8. Hex Key Port 8 may couple Housing 5 to Mounting Plate 35, when Hex Screw 43 is securely fastened through Hex Key Port 8. Faceplate 1 may wrap around the front and sides of Housing 5, and may be secured to the back of Housing 5 using screws, fasteners or adhesive. In one non-limiting aspect of the present disclosure, Faceplate 1 may be removed, and faceplates of different colors or materials may replace Faceplate 1 on Housing 5.

FIG. 7 shows a back perspective view of Wireless Communication Doorbell 61 coupled to Mounting Plate 35, according to an aspect of present disclosure. As described above in FIG. 6b, Faceplate 1 wraps around the back of Housing 5 and is secured using screws or fasteners. In one aspect of the present disclosure, Faceplate 1 may be adhered to Housing 5 without using fasteners. Faceplate 1 may be magnetically adhered, glued, or snapped onto Housing 5 without the need to wrap Faceplate 1 around the back of Housing 5.

Mounting Plate 35 may have multiple Mounting Plate Screw Ports 36, to allow user 62 to securely install Mounting Plate 35 to an exterior surface using fasteners, screws or adhesives. In one aspect, Mounting Plate 35 sits inside Housing 5 when Wireless Communication Doorbell 61 is mounted to Mounting Plate 35, so Wireless Communication Doorbell 61 sits flush against the User 62's preferred mounting surface such as a doorway, wall or an exterior or a structure. Hex Screw 43 may be fastened through Hex Key Port on the bottom of Housing 5 and tightened up against the bottom of Mounting Plate 35 to secure Wireless Communication Doorbell 61. Wire Access Port 38 may have Wire Guides 39 protruding from adjacent side walls of Wire Access Port 38 to assist in guiding Electrical Wires 60 up to Conductive Fittings 41 (shown in FIG. 5).

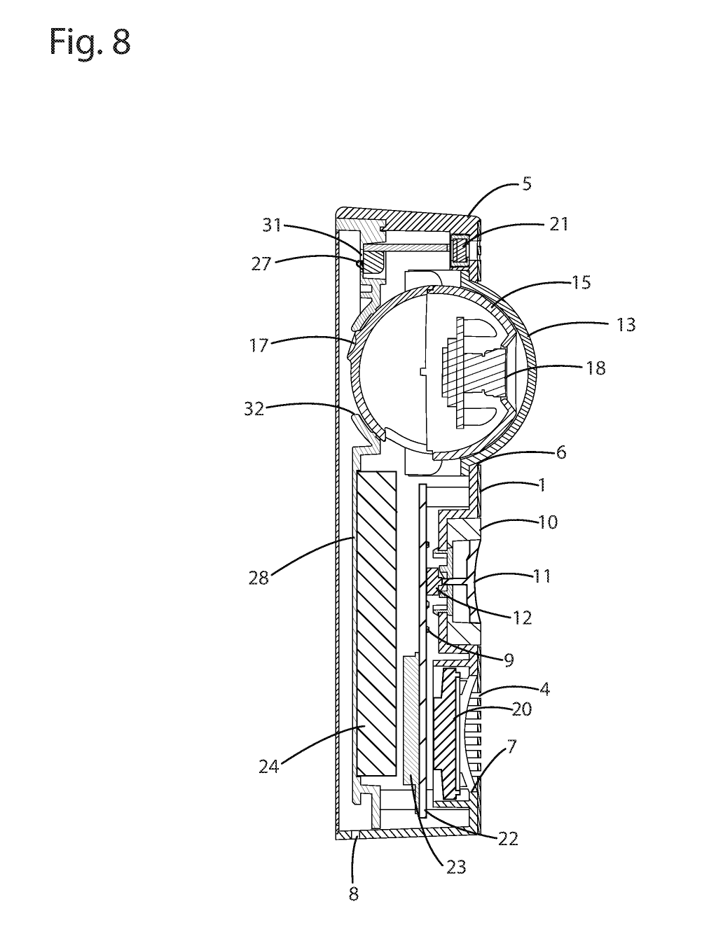

FIG. 8 displays a section view of Wireless Communication Doorbell according to an aspect of present disclosure. Housing 5 may be made of any non-porous material, such as injection molded plastic, milled aluminum, metal or wood. Housing 5 may be capable of protecting all components within Wireless Communication Doorbell 61 from weather elements, without limiting the functionality of the components. Housing 5 may have Audio Aperture 7 to allow for audio emitted from Visitor 63 to be received by Microphone 21, as well as Audio Aperture 7 for emitting audio through Speaker 20 to Visitor 63. If Faceplate 1 is mounted to Housing 5, Faceplate 1 may have Perforated Pattern 4 that channels sound to and from the Wireless Communication Doorbell 61. Microphone 21 and Speaker 20 are mounted within Housing 5 and are connected to Microcontroller 22. Audio data is received wirelessly by Wireless Communication Doorbell 61 and processed by Communications Module 23 and Microcontroller 22. Microcontroller may then send the audio signal to Speaker 20 where it is then delivered to Visitor 63. When Visitor 63 responds, the audio is received by Microphone 21 and Microcontroller 22, processed and transmitted wirelessly by Communications Module 23.

Housing 5 may contain an inset portion on the exterior front face, positioned to align with Button Aperture 3 on Faceplate 1. Button 11 and Led Light Pipe 10 may be mounted within the inset portion and protrude through Button Aperture 3. Button 11 may have an extruded stem on the back face, which may protrude through Housing 5, and make contact with Button Actuator 12 when pressed by Visitor 63. Button Actuator 12 may be mounted to Microcontroller 22 within Housing 5, and when activated may trigger multiple components within Wireless Communication Doorbell 61 to activate. Such components include the activation of Camera 18, Night Vision LEDs 19, Communications Module 23, Speaker 20, Microphone 21, and Surface Mount LEDs 9. Surface Mount LEDs 9 are mounted to Microcontroller 22, upon activation, they illuminate Light Pipe 10 which protrudes through Button Aperture 3 along with Button 11. Light Pipe 10 is an extruded transparent ring that encases Button 11. Light Pipe 10 may be any material capable of projecting light, such as glass or transparent plastic, from Surface Mount LEDs 9 out to exterior front face of Wireless Communication Doorbell 61. Surface Mount LEDs 9 may indicate several things to Visitor 63 and User 62. Surface Mount LEDs 9 may light up upon activation or stay illuminated continuously. In one aspect, Surface Mount LEDs 9 may change color to indicate that Button 11 has been pressed. Surface Mount LEDs 9 may also indicate that Battery 24 is being charged, charging has been completed, or that Battery 24 is low. Surface Mount LEDs 9 may indicate that connection to User's Network 65 is good, limited, poor, or not connected amongst other conditions. Surface Mount LEDs 9 may be used to guide User 62 through setup or installation steps using visual cues, potentially coupled with audio cues emitted from Speaker 20.

Microcontroller 22 is mounted within Housing 5 using fasteners, screws or adhesive. Microcontroller 22 is a small computer on a single integrated circuit containing a processor core, memory, and programmable input/output peripherals. In one non-limiting example, Microcontroller 22 may be an off-the-shelf component. Microcontroller 22 may have processors on board, or coupled thereto, to assist in the compression and conversion of audio and/or video. Microcontroller 22 may also have or be coupled to Flash Memory 45 and RAM 46 (shown in FIG. 11) to install and execute software which may be delivered or updated through Micro USB Input 26. Communications Module 23 may be embedded or coupled to Microcontroller 22, allowing for data derived from Microcontroller 22 to be sent out wirelessly.

Battery 24 may be mounted within Housing 5 and provide power to any components needing power within Wireless Communication Doorbell 61. Battery 24 may be a single or multi-celled battery, which may be rechargeable such as rechargeable lithium ion batteries or rechargeable nickel-metal hydride batteries. In this aspect, Battery 24 may be recharged via Micro USB Input 26 (shown in FIG. 4). Micro USB Input 26 is mounted within Housing 5 and protrudes out of USB Input Port 29, located on an exterior surface of Housing Enclosure 28. Battery 24 may also be charged from drawing power from Electrical Wiring 60, derived from the building that Wireless Communication Doorbell 61 may be mounted to. In this aspect and explained in further detail in FIG. 5, when Wireless Communication Doorbell 61 is mounted to Mounting Plate 35, Conductive Plate 40 may make direct contact with Conductive Prongs 27, thus transferring electric current to Conductive Prongs 27. Conductive Prongs 27 may be located within Housing 5, and protrude through Conductive Prong Port 31, located on an exterior face of Housing Enclosure 28. When charged with an electric current, Conductive Prongs 27 may charge Battery 24 or directly power components within Wireless Communication Doorbell 61.

Still referencing FIG. 8, Housing 5 may contain Housing Dome Aperture 6, which allows Camera Ball Assembly 15 and Clear Dome 13 to protrude out from within Housing 5. Clear Dome 13 may be secured to Housing 5 using fasteners, screws or adhesive. Clear Dome 13 may be any material that has transparent characteristics such as clear plastic or glass. Camera Ball Assembly 15 may reside within Clear Dome 13 and may be a hollow plastic housing containing Camera 18 and Night Vision LEDs 19. Camera 18 may record still or moving video, (e.g. anyone who activates Wireless Communication Doorbell 61 by pressing Button 8, or triggering Infrared Sensor 42). Camera 18 may send the recorded video or images to Microcontroller 22, to be sent to Smart Device 54 and Database 64 via Communications Module 23. Night Vision LEDs 19 (shown in FIG. 9a) may be activated by Microcontroller 22, depending on the time of day, to help illuminate the area in front of Wireless Communication Doorbell 61 when necessary. Microcontroller 22 may illuminate Night Vision LEDs 19 using a timer, which may trigger Night Vision LEDs 19 to turn on or off at a certain time each day. In one aspect of the present disclosure, Night Vision LEDs 19 may be triggered by a light sensor (not shown) mounted within Housing 5. In this aspect, when the absence of light is detected by said light sensor, the sensor may notify Microcontroller 22, which would trigger the activation of Night Vision LEDs 19.

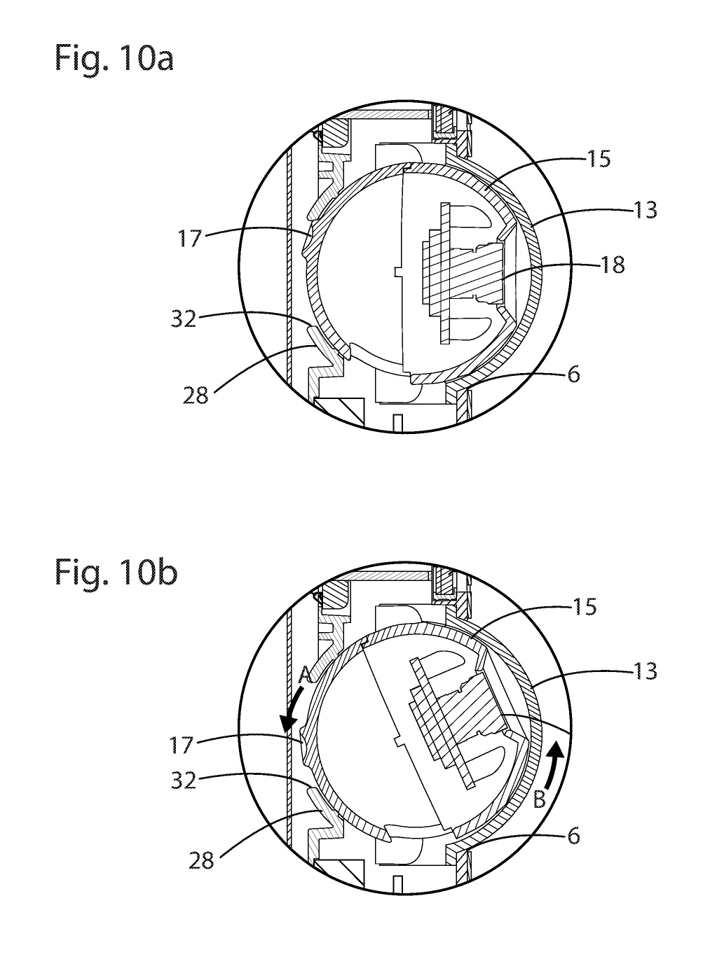

Camera Ball Assembly 15 may contain Camera Ball Rotation Dimple 17. Camera Ball Assembly Rotation Dimple 17 is a physical input located on the back exterior face of Camera Ball Assembly 15. Camera Ball Assembly Rotation Dimple 17 may be used to accumulate leverage to rotate Camera Ball Assembly 15 within Housing 5. As explained in further detail in FIGS. 10a and 10b, pushing down on Camera Ball Assembly Rotation Dimple 17 allows Camera Ball Assembly 15 to be rotated vertically, pointing Camera 18 up, and vice versa. Camera Ball Assembly Rotation Dimple 17 may be accessed via Rotation Dimple Access Port 32 located on the back of Housing Enclosure 28. Housing Enclosure 28 is coupled to Housing 5 using screws, fasteners or adhesive.

FIGS. 9a and 9b displays Camera Assembly 15 and Clear Dome 13 according to aspect of the present disclosure. Camera Assembly 15 may be a hollow, spherical assembly that houses Camera 18 and Night Vision LED's 19. Night Vision LED's may be coupled to Camera 18 and Microcontroller 22, and illuminate the area surrounding the Wireless Communication Doorbell 61. The said illumination may provide User 62 the visibility necessary to see Visitor 63 through Camera 18 at night or when visibility is poor.

Camera Ball Assembly 15 may contain Camera Ball Assembly Track Pins 16 protruding from adjacent exterior surfaces of Camera Ball Assembly 15. Camera Ball Assembly Track Pins 16 share the same profile associated with Clear Dome Tracks 14. Clear Dome Tracks 14 may be grooves inset into adjacent interior walls of Clear Dome 13. Clear Dome 13 is a transparent dome shaped component, made of injection molded plastic, glass, or any other material with transparent characteristics. Clear Dome 13 mounts to the interior of Housing 5 and protrudes through Housing Dome Aperture 6.

As shown in FIG. 9b, Camera Ball Assembly 15 may be set within Clear Dome 13. Camera Ball Assembly 15 may have a smaller diameter in comparison to Clear Dome 13, thus facilitating movement of Camera Ball Assembly 15 within Clear Dome 13. When Camera Ball Assembly Track Pins 16 are set into Clear Dome Tracks 14, Camera Ball Assembly 15 may be coupled to Clear Dome 13. As a result of coupling, the Camera Ball Assembly 15 may pivot in multiple directions throughout Clear Dome 13.

FIG. 10a and FIG. 10b display section views from the side of Camera Assembly 15, coupled to Clear Dome 13 within Housing 5, according to an aspect of the present disclosure. When Camera Assembly 15 is coupled to Clear Dome 13, User 62 may pivot Camera Assembly 15 via Camera Ball Assembly Rotation Dimple 17. Camera Ball Assembly Rotation Dimple 17 may be located on the back facing exterior surface of Camera Ball Assembly 15. Camera Ball Assembly Rotation Dimple 17 protrudes through Rotation Dimple Access Port 31, located on Housing Enclosure 28. Camera Ball Assembly Rotation Dimple 17 may act as a handle to be moved about within Rotation Dimple Access Port 31 by User 62. As shown in FIG. 10a, prior to applying pressure to Camera Ball Assembly Rotation Dimple 17, Camera 18 may be directed straight ahead. As displayed in FIG. 10b, when a downward force (Arrow A) is applied to Camera Ball Assembly Rotation Dimple 17 by User 62, Camera 18 is directed upwards (Arrow B). The action displayed herein may be applied to Camera Ball Assembly Rotation Dimple 17 to rotate Camera 18 and Camera Ball Assembly 15 in various directions, so User 62 may have the best possible view of Visitor 63.

FIGS. 11a and 11b display section views from above of Camera Assembly 15, coupled to Clear Dome 13 within Housing 5, according to an aspect of the present disclosure. These views display the curvature of Clear Dome Tracks 14, which follow the curvature of Clear Dome 13. When Camera Assembly Track Pins 16 are set within Clear Dome Tracks 14, Camera Assembly 15 may rotate about Clear Dome Tracks 14, following the curvature of Clear Dome 13. Using Camera Ball Assembly Rotation Dimple 17, User 62 may rotate Camera Assembly 15 in the direction of Visitor 63. As shown in FIG. 11a, prior to applying pressure to Camera Ball Assembly Rotation Dimple 17, Camera 18 is directed straight ahead. As displayed in FIG. 11b, when a directional force (Arrow A) is applied to Camera Ball Assembly Rotation Dimple 17 by User 62, Camera 18 is directed in the opposite direction (Arrow B). In one aspect, Clear Dome Tracks 14 may partially follow the curvature displayed in Clear Dome 13. In this aspect, Camera Assembly 15 may only rotate about Clear Dome Tracks 14 until Clear Dome Tracks stop.

In one aspect of the present disclosure, Camera Ball Assembly Rotation Dimple 17 may contain a port that accepts a tool such as a screw driver (e.g., Phillips or flat head), hex key or Allen key. The tool (not shown) allows for easier rotation of Camera Ball Assembly 15 using the leverage acquired by inserting the tool into the port. In another aspect of the present disclosure, the mechanism described in FIG. 10 and FIG. 11 may be achieved electronically, using a series of motors and gears. In this aspect, User 62 may be capable of rotating Camera Ball Assembly 15 via Application 55 installed on Smart Device 54. Increased functionality may be capable in this aspect, such as panning, zooming and tracking the movements of Visitor 63, resulting in more visibility at User 62's doorstep.

FIG. 12 is an entity relationship diagram of the application and components within Wireless Communication Doorbell according to an aspect of the present disclosure. As shown in FIG. 12, Visitor 63 may initiate communication with User 62 by pressing Button 11 on the front face of Wireless Communication Doorbell 61. Pressing Button 11 may trigger Microcontroller 22 to signal Power Processor 51 to increase the power distribution levels to the rest of the device. Power Processor 51 is a processor that may manage the distribution of energy from Battery 24 to the components within Wireless Communication Device 61 such as Speaker 20, Microphone 21, Night Vision LEDs 19, Camera 18, Infrared Sensor 49, Microcontroller 22 and Communications Module 23. Battery 24 holds the power that Power Processor 51 used to distribute to all components within Wireless Communication Device 61. Battery 24 may be recharged via Micro USB Input 26. Micro USB Input 26 is mounted within Housing 5 and protrudes out of USB Input Port 29, located on an exterior surface of Housing Enclosure 28. Micro USB Input 26 is connected to Microcontroller 22, which may relay power to Battery 24 for charging. Battery 24 may also be charged from drawing power from Electrical Wiring 60, derived from the building that Wireless Communication Doorbell 61 may be mounted to. To draw power from Electrical Wiring 60, the electric current may be passed through Conductive Fittings 41, along to Conductive Plate 40, mounted on Mounting Plate 35 (not shown in FIG. 9). Conductive Plate 40 makes contact with Conductive Prongs 27 when Wireless Communication Doorbell 61 is mounted to Mounting Plate 35, transferring the electric current to Conductive Prongs 27. Conductive Prongs 27 are mounted with Housing 5, and protrude through Conductive Prong Port 31, located on an exterior face of Housing Enclosure 28. Conductive Prongs 27 transfer electric current derived from Electrical Wiring 60 to Microcontroller 22. Microcontroller 22 then relays the power directly to Battery 24.

In some embodiments, the infrared sensor 49 may comprise any sensor capable of detecting and communicating the presence of a heat source within its field of view. For example, the infrared sensor 49 may comprise one or more passive infrared sensors (PIRs). The infrared sensor 49 may be used to detect motion in the area about the wireless communication doorbell 61. Alternatively, or in addition, the present embodiments may use the camera 18 to detect motion. For example, detecting motion may comprise comparing video frames recorded by the camera 18. The microcontroller 22 may comprise a sensor interface 44 that facilitates communication between the infrared sensor 49 and the microcontroller 22.

As shown in FIG. 12, after the initial trigger created by pressing Button 11, Power Processor 51 may distribute power to Surface Mount LEDs 9. Surface Mount LEDs 9 illuminate Light Pipe 10 surrounding Button 11, providing a visual cue to Visitor 63 that their request has been processed. Surface Mount LEDs 9 may continue to stay illuminated, or shut off after Visitor 63 releases Button 11. Surface Mount LEDs 9 may provide other visual cues indicating that Battery 24 is being charged, charging has been completed, or that Battery 24 is running low. Surface Mount LEDs 9 may also indicate that connection to User's Network 65 is good, limited, poor, or not connected, amongst other potential indicators. Surface Mount LEDs 9 may be used to guide User 62 through setup or installation steps using visual cues, potentially coupled with audio cues emitted from Speaker 20.

In reference to FIG. 12, after Button 11 is pressed, Power Processor 51 may provide the power to activate Camera 18 and Night Vision LEDs 19. Camera 18 records any visuals of Visitor 63 and processes the visuals using CCD/CMOS Sensor 66. The visuals recorded may be a still image or video, based on one or more factors including user settings, signal strength, and power available. In one non-limiting example, CCD/CMOS Sensor 66 may be the OmniVision OV7740/OV780 which is a low power, high sensitivity image sensor capable of managing all image processing procedures. Other image sensors may be used having similar characteristics. The processed visuals are then converted to digital data by CCD/CMOS A 50, to be distributed to System Network 52 via Communications Module 23. CCD/CMOS AFE 50 stands for analog front end sensor and may convert video or still images into a format capable of being transmitted. In one aspect of the present disclosure, the video and/or still images recorded by Camera 18 may be collected and stored in Database 64 within System Network 52, in conjunction with the routing of said video and/or still images. User 62 may be able to access Database 64, via Application 55, installed on Smart Device 54, to view still images or video taken by Wireless Communication Doorbell 61.

As displayed in FIG. 12, Communications Module 23 may be an off-the-shelf component, or it may be any other module that adds low power, high speed Wi-Fi and Internet connectivity to any device with a microcontroller and serial host interface. Other data transmission protocols such as Bluetooth or ZigBee may be incorporated into the Communications Module 23 to transmit data to mobile devices or any other device capable of receiving wireless data transmissions. Communications Module 23 sends outbound data to System Network 52, containing data such as video, audio, and identifying information related to Wireless Communication Doorbell 61. System Network 52 may be a telecommunications network that allows computers to exchange data either physically or virtually. In one aspect, System Network 52 may be a virtual network that identifies Smart Device 54 associated with Wireless Communication Doorbell 61 using the identifying information sent. Once the identifying information matches Smart Device 54, System Network 52 routes the data through Server 53 to Smart Device 54. Server 53 is a system that responds to requests across a computer network to provide, or help to provide, a network service, such as the routing of data according to instructions and user preferences. Wireless Communication Doorbell 61 may be connected to User's Network 65 for Communications Module 23 to communicate with Smart Device 54 via System Network 52.

Once connected to User's Network 65, data sent from Wireless Communication Doorbell 61 may be routed by Server 53 to devices associated with Wireless Communication Doorbell 61. Thus, Wireless Communication Doorbell 61 may send data to Smart Device 54 or web based applications such as Skype via System Network 52, so long as they are associated with Wireless Communication Doorbell 61 and have an associated data source name. Wireless Communication Doorbell 61 may also connect to other devices such as a television, landline phone, or send simple SMS messages to non-smart devices by converting the audio, video and data transmissions to the applicable formats. In this aspect, a Smart Device 54, web based application or any other device associated with Wireless Communication Doorbell 61 may be identified by Server 53. Server 53 may then process audio, video and any other data to the appropriate format needed to transmit said data to the appropriate Smart Device 54, web based application or any other device capable of receiving and transmitting audio, video and or other data.

Smart Device 54 may be any electronic device capable of receiving and transmitting data via the internet, capable of transmitting and receiving audio and video communications, and can operate to some extent autonomously. Examples of Smart Device 54's are but not limited to smartphones, tablets, laptops, computers and VOIP telephone systems. The infrastructure described above allows User 62 to connect multiple Smart Devices 54, within the parameters just mentioned, to Wireless Communication Doorbell 61. In this aspect, multiple authorized User's 62 may see who is within view of Wireless Communication Doorbell 61 at any given time. In one aspect of the present disclosure, the authorized User 62 who first responds to Accept/Deny Prompt 56 will be placed in communication with Visitor 63. In another aspect System Network 52 may be able to connect multiple Users 62, associated with the same Wireless Communication Doorbell 61, with Visitor 63 on the same call, in a similar fashion to a conference call.

Application 55 may be installed on Smart Device 54 and provide an interface for User 62 to communicate and interact with Wireless Communication Doorbell 61. Other than communicating with Visitor 63, User 62 may be able to perform functions via Application 55 such as adjust the volume emitted from Speaker 20, rotate Camera Ball Assembly 15, focus or zoom Camera 18 and turn Night Vision LEDs 19 on or off, amongst other functions. Application 55 may also display data such as the battery life left in Battery 24, videos and still images recorded by Camera 18, voicemails left by Visitor 63 and information regarding recent Visitors 63 such as date, time, location and Wireless Communication Doorbell 61 identifying information. Smart Device 54 may provide an interface for User 62 to receive weekly, monthly or annual diagnostic and activity reports, which may display information such as the number of visitors per day, per month, and per year for example. Diagnostic data may include wireless connectivity data, and battery life data amongst other data.

As shown in FIG. 12, Application 55 may communicate with Third Party Application 57 via the use of APIs and software developer kits. Third Party Application may be installed on Smart Device 54 and associated with Third Party Hardware 58. Third Party Hardware may be a device using wireless communication protocols to initiate physical tasks through Third Party Application 57. For example, Wireless Communication Doorbell 61 may be compatible with a smart lock, such as Lockitron, which allows User 62 to lock and unlock a door through the use of a smart device application, such as Third Party Application 57. Using this example, after User 62 communicates with Visitor 63 via Application 55, User 62 may trigger Application 55 to send out an API call through System Network 52 to Third Party Application 57 (Lockitron application) to unlock the door using Third Party Hardware 58 (Lockitron hardware).

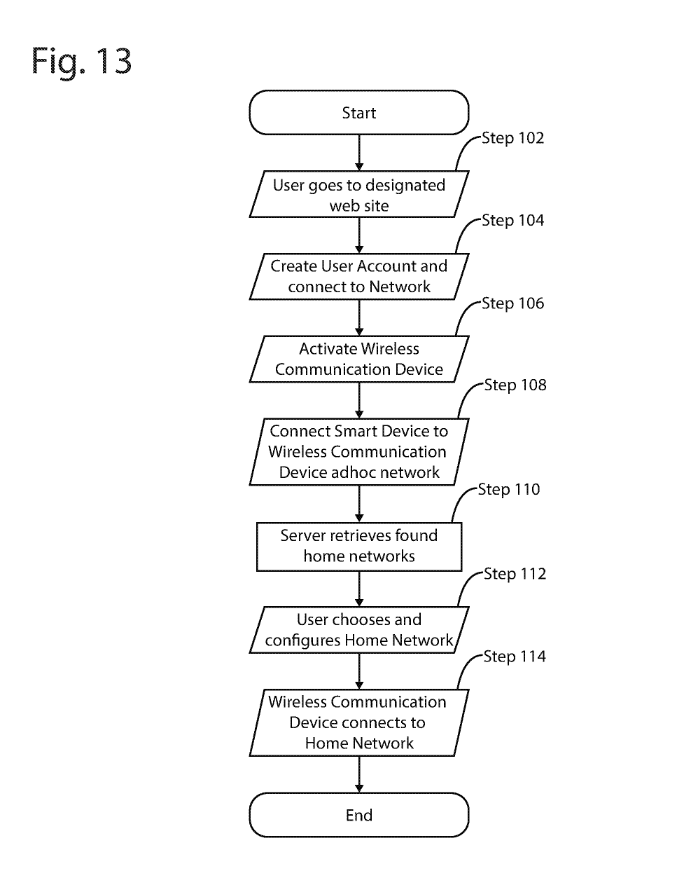

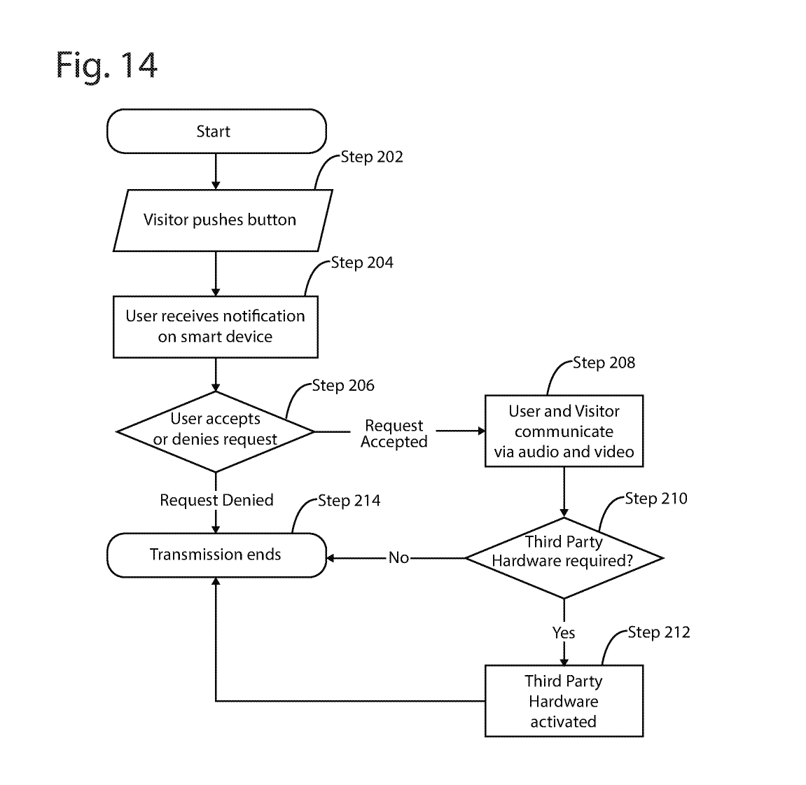

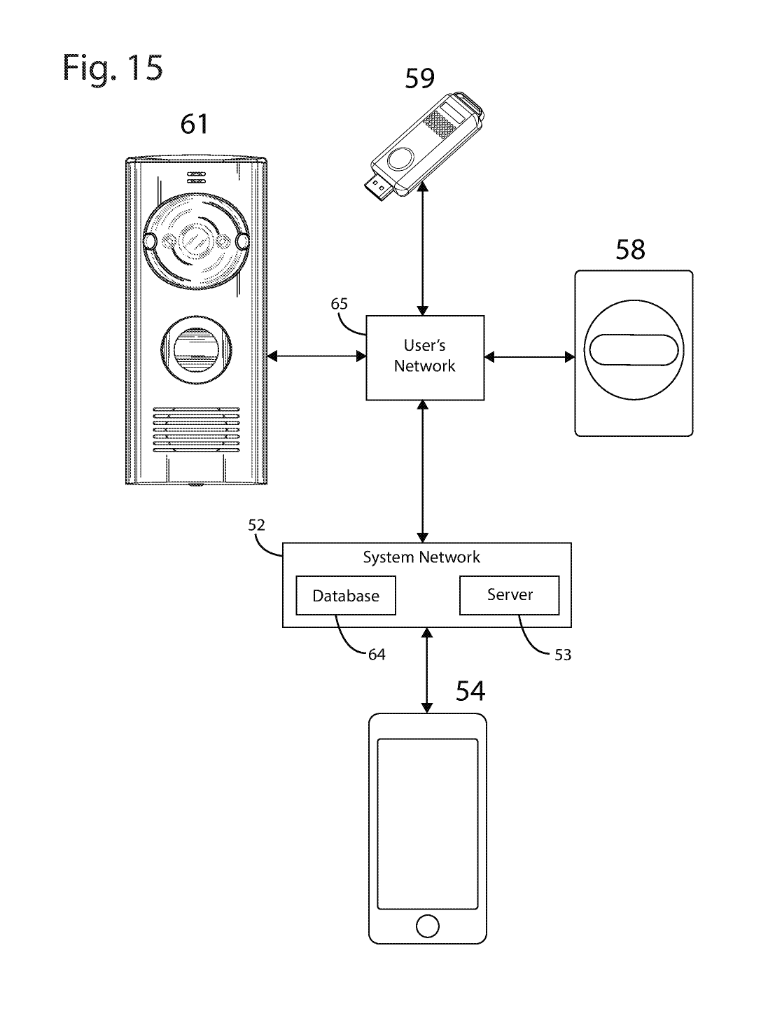

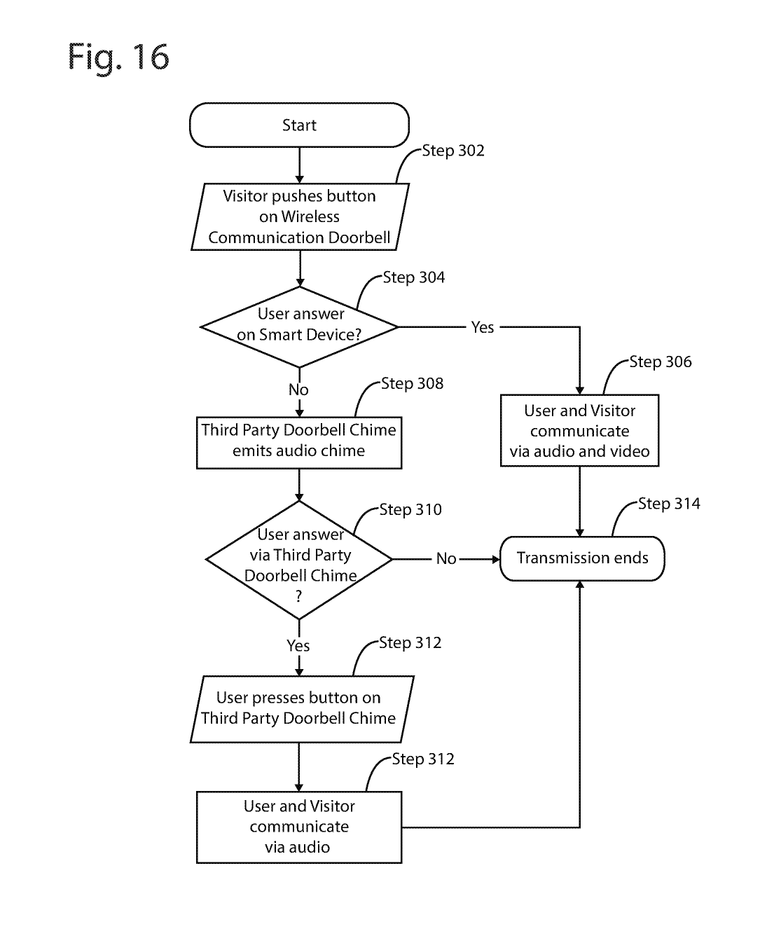

FIG. 15 is a diagram displaying multiple devices in communication according to the system and method of present disclosure. The communication protocol displayed in FIG. 11 is Wi-Fi, and is one method of wireless data exchange according to an aspect of the present disclosure. The devices within the system may connect to User's Network 65 using methods such as the process flow described in FIG. 13. User's Network 65 may be a local area network (LAN), internet area network (IAN) or a wide area network (WAN) that connects voice and data end points within a wireless network. Once devices within the system are connected to User's Network 65 (unless equipped with 3G, 4G, LTE, etc.), then the devices may communicate by sending data to System Network 52. System Network 52 is wireless telecommunications network that allows for the transfer of data to and from Wi-Fi enabled devices. Server 53 may be embedded in or coupled to System Network 52. Server 53 is a system that responds to requests across a computer network to provide, or help to provide, a network service, such as the routing of data according to instructions and user preferences. Devices within the system send data to System Network 52 where Server 53 processes and routes the data to the appropriate device. For example, data from Wireless Communication Doorbell 61 may be sent to System Network 52, such as identifying information, digital audio, processed visuals and device diagnostics. Server 53 processes the data sent from Wireless Communication Doorbell 61 and routes it accordingly to the other devices within the system. For instance, Server 53 may process diagnostic data sent from Wireless Communication Doorbell 61, and Server 53 routes the diagnostic data to inform User 62 via Smart Device 54 if Battery 24 is about to die (e.g. 10% battery remaining).

In one aspect of the present disclosure, all devices that communicate within the system described in FIG. 15 may use other wireless communication protocols, such as Bluetooth. Bluetooth is a wireless technology standard for exchanging data over short distances, in this aspect, all devices must be within close proximity to communicate. Bluetooth wireless transmission does not require the use of a System Network 52 or Server 53 because of the close proximity, while maintaining the capability to transfer data such as identifying information, digital audio, processed visuals and device diagnostics.

In one method and system of the present disclosure, all hardware components within Wireless Communication Doorbell 61 may live in a state of hibernation until Button 11 is pressed by Visitor 63. In this aspect, all components that draw power from Battery 24, such as Communications Module 23 and Camera 18 do not waste battery power when not in use. When Button 11 is pressed, it may activate all components, and when streaming data to Smart Device 54 ceases, all components may return to hibernation mode.

In one aspect of the present disclosure, diagnostic data associated with Wireless Communication Doorbell 61, such as battery life and internet connectivity, may be relayed to System Network 52 when Communication Module 23 is woken up out of hibernation mode. With the diagnostic data provided by Wireless Communication Doorbell 61, Server 53 may send notifications to Smart Device 54, informing User 62 to charge Battery 24 or reset the internet connectivity to Wireless Communication Doorbell 61.

### Visitor Recognition Processing

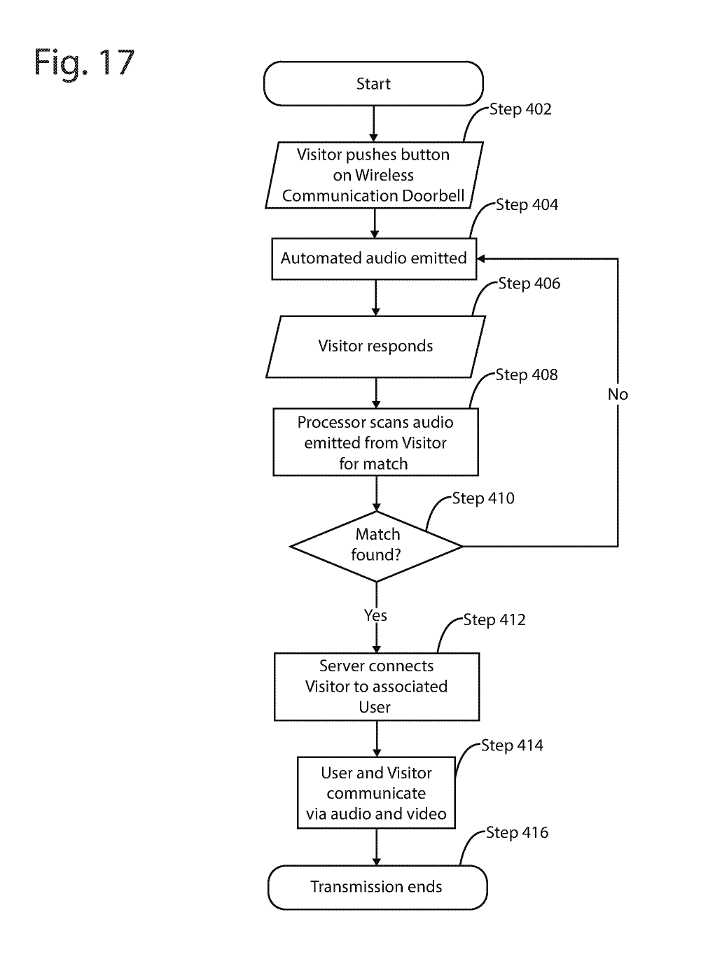

FIG. 17 is a process flow describing the steps involved in performing speech recognition to acknowledge Visitors 63 and route them to the appropriate User 62. In one aspect of the present disclosure, Wireless Communication Doorbell 61 may come equipped with software either embedded or coupled to Microcontroller 22 or another component of Wireless Communication Doorbell 61 capable of performing speech recognition. In one non-limiting example, Wireless Communication Doorbell 61 may act as a front desk assistant and would be capable of acknowledging new Visitors 63 upon arrival to a location, such as an office.

In this aspect, Visitor 63 may push Button 11 located on the front face of Wireless Communication Doorbell 61 at Step 402. Pressing Button 11 triggers automated or pre-recorded audio to be emitted from Speaker 20 within Wireless Communication Doorbell 61 at Step 404. In one aspect, the automated or pre-recorded audio may be triggered to be emitted when Visitor 63 crosses Infrared Sensor 49. The automated or pre-recorded message at Step 404 may request Visitor 63 to say what User 62 they intend to meet or talk to.

At Step 406, Visitor 63 may speak into Microphone 21, saying what User 62 they intend to meet or talk to. The spoken words emitted from Visitor 63 may be processed by the speech recognition software within Wireless Communication Doorbell 61 at Step 408. Using standard speech recognition processing, the spoken words emitted from Visitor 63 are interpreted into an audio file format capable of being compared with audio files stored within Database 64 at Step 410. If a biometric match is found (Yes, Step 410), Server 53 routes data to the Smart Device 54 associated with the User 62 associated with the biometric match.

If a biometric match is not found, (No, Step 410) an automated or pre-recorded message at Step 404 may request Visitor 63 to say what User 62 they intend to meet or talk to. Steps 406 through 410 may then be repeated until a biometric match is found. In one aspect, after a predetermined number of failed attempts, Visitor 63 may be directed via Server 53 to User 62 capable of manually routing Visitor 63 to the correct User 62. Once a Visitor 63 is connected to the correct User 62, Visitor 63 and User 62 communicate via video and audio transmitted sent to and from Wireless Communication Doorbell 61 and Smart Device 54 at Step 414. Wireless data transmission may be terminated at Step 416.

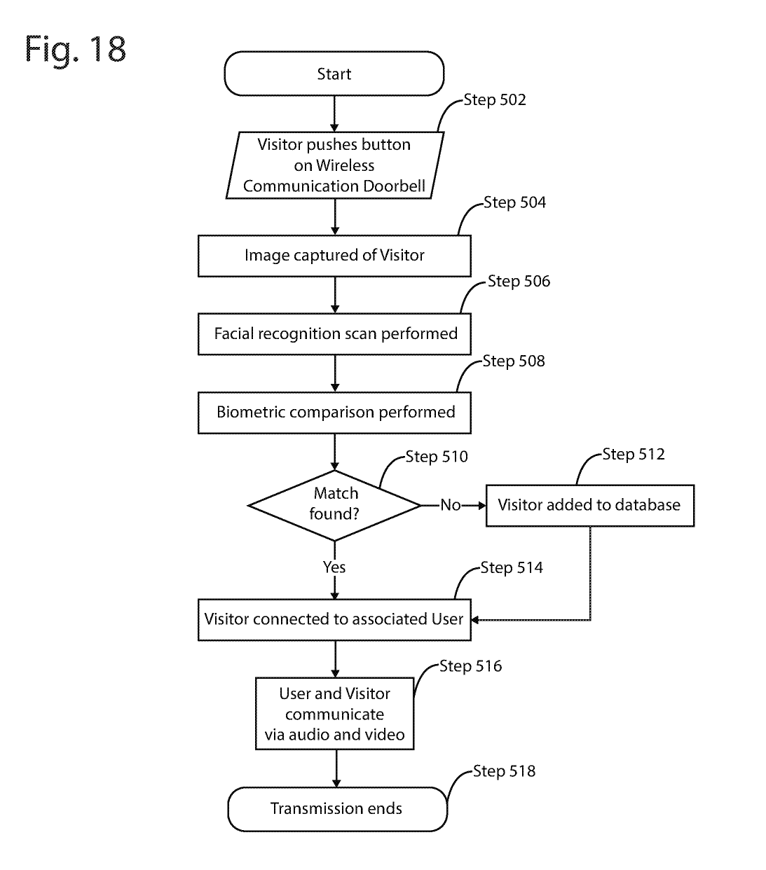

FIG. 18 is a process flow describing the steps involved in performing facial recognition to acknowledge Visitors 63 and route them to the appropriate User 62. In one aspect of the present disclosure, Wireless Communication Doorbell 61 may come equipped with software either embedded or coupled to Microcontroller 22, Camera 18 or another component of Wireless Communication Doorbell 61 capable of performing facial recognition, or another form of physical recognition such as iris scanning, fingerprint scanning, etc. In one non-limiting example, Wireless Communication Doorbell 61 may act as a front desk assistant and would be capable of acknowledging Visitors 63 upon arrival to a location, such as an office, and route them to the correct User 62.

In this aspect, Visitor 63 may push Button 11 located on the front face of Wireless Communication Doorbell 61 at Step 502. Pressing Button 11 triggers Camera 18 to take one or more photos of Visitor 63 at Step 504. In one aspect, Camera 18 be triggered to take photos when Visitor 63 crosses Infrared Sensor 49. At Step 506, the image captured of Visitor 63 may be processed by facial recognition software within Wireless Communication Doorbell 61. In one aspect, the facial recognition software may identify facial features by extracting landmarks, or features, from an image of the subject's face. For example, an algorithm may analyze the relative position, size, and/or shape of the eyes, nose, cheekbones, and jaw. These features are then used create a biometric comparison against other images within Database 64 with matching features at Step 508.

If a biometric match is found in Database 64 (Yes, Step 510), Server 53 routes Visitor 63 to the appropriate User 62 at Step 514. Server 53 may have data associated to Visitor 63, such as a calendar event, which may help direct Visitor 63 to the correct User 62. In the event that no biometric match is found in Database 64 (No, Step 510), Image data acquired from the facial recognition software is distributed to Database 64, for future reference. Server 53 may then route the image captured by Camera 18 of Visitor 63, accompanied with a Request/Deny Prompt 56 to all Smart Devices 54 associated with Wireless Communication Doorbell 61. The User 62 that accepts the Request/Deny prompt 56 may then be connected to User 62 at Step 514.

In one non-limiting aspect, Server 53 may use APIs and software developer kits to acquire images of people associated with Users 62 from social media websites and applications. For example, Server 53 may acquire images of User 62's friends on Facebook, Google Plus, Twitter, Instagram, etc. These images may then be processed using the facial recognition software and compared against the images captured of Visitor 63 by Camera 18 in search for a biometric match.

Once a Visitor 63 has been correctly associated with a User 62, Server 53 may route all data transmissions coming from Wireless Communication Doorbell 61 to Smart Device 54 associated with User 62. Visitor 63 and User 62 communicate via video and audio transmitted to and from Wireless Communication Doorbell 61 and Smart Device 54 at Step 516. Wireless data transmission may be terminated at Step 518.

One aspect of the present embodiments includes the realization that the functionality of some A/V recording and communication devices is limited by their lack of traditional input devices, such as keypads. The present embodiments solve this problem by leveraging the capabilities of the camera of the A/V recording and communication device. For example, as described in further detail below, some of the present embodiments enable the A/V recording and communication device to be used to perform a variety of tasks based on an input of a user gesture performed within the field of view of the camera. Non-limiting examples of tasks that can be accomplished with user gestures include, but are not limited to, gaining access to the home (or other structure associated with the A/V recording and communication device), executing tasks within the home, and notifying person(s) within the home of a person's arrival.

In one non-limiting aspect of the present disclosure, the wireless communication doorbell 61 may further comprise a gesture recognition module 70 (FIG. 12) for recognizing and interpreting user gestures. In one non-limiting aspect, these gestures may be made by the visitor 63, for example, making motions with his/her hands within the field of view of the camera 18. Video of a user gesture recorded by the camera 18 may be passed to the gesture recognition module 70 (e.g., via the microcontroller 22), which may then interpret the gesture.

In one aspect, gesture data may be maintained in a memory accessible to the gesture recognition module 70. For example, the gesture data may be stored at any (or all) of the flash memory 45, the RAM 46 and/or the ROM 47, and/or in another memory (not shown) of the gesture recognition module 70, and/or in another memory at a remote location, such as the server 53, the database 64, and/or the API (application programming interface) 76, and operatively coupled to the gesture recognition module 70 and/or the microcontroller 22 via a network, which may be wired and/or wireless. The gesture data may comprise information sufficient to enable the gesture recognition module 70 to identify the user gesture based on the video recorded by the camera 18. The gesture data may include information about any one of and/or any combination of: sign language, facial expressions, facial recognition, facial recognition combined with a gesture, hand gestures on a flat plane, hand gestures in a 3D space, a printed key, a visual passcode/key worn by the user (e.g., on a bracelet or another piece of jewelry or on clothing), shapes drawn with hands on the body, eyes blinking in predefined pattern(s), sequences of fingers showing numbers, sequences of hand gestures, the homeowner's natural body movement, an object positioned and/or moved within the camera's field of view, head movements (e.g., a sequence of head movements such as left, left, left, right, down), a sequence of different faces, facial recognition combined with a verbal unlock code/command, closeup scanning of hand or finger (via a fingerprint reader, or by the camera), voice recognition, and biometric data. The present embodiments may comprise other gesture data, and the foregoing list should not be interpreted as limiting in any way.

In the illustrated embodiment, the gesture recognition module 70 is operatively coupled to the microcontroller 22, and may receive video recorded by the camera 18 via the microcontroller 22. In alternative embodiments, the gesture recognition module 70 may be operatively coupled directly to the camera 18 so that video recorded by the camera 18 may be passed directly from the camera 18 to the gesture recognition module 70. In some embodiments, the gesture recognition module 70 may be operatively coupled directly to both the camera 18 and the microcontroller 22.

In one aspect, the gesture data may be associated with a set of executable commands. The executable commands may include, for example, and without limitation, unlocking a door, disarming a security system, beginning an intercom session, transmitting a prerecorded audio message to another unit, playing an audio message via the speaker 20, sending a text-based (e.g., SMS or e-mail) message to a phone number or an e-mail address, sending a message to another connected device, setting other connected devices to different modes (such as high alert modes), alerting authorities, turning on lights, turning off lights, triggering an audible system status, entering another mode in which the user can trigger more commands either verbally or through gestures, stopping recording, starting recording, or changing settings. The present embodiments may comprise other commands, and the foregoing list should not be interpreted as limiting in any way. The executable commands may be associated with the gesture data, so that when a person in view of the camera 18 successfully replicates a gesture matching a gesture from among the stored gesture data (the “matched gesture”), the command associated with the matched gesture is executed. For example, in some embodiments the gesture recognition module 70 may receive as an input video recorded by the camera 18 (either directly from the camera 18 or via the microcontroller 22), determine whether the video includes a user gesture that matches a gesture from among the stored gesture data, and, if a match is found, generate as an output the command associated with the matched gesture. The output command may be sent to the microcontroller 22 and/or to another component for executing the command.

As described above, gesture data may be stored at a memory accessible to the gesture recognition module 70, such as at any (or all) of the flash memory 45, the RAM 46, the ROM 47, the server 53, the database 64, and/or the API 76. Similarly, information about executable commands associated with each user gesture may be stored at a memory accessible to the gesture recognition module 70, such as at any (or all) of the flash memory 45, the RAM 46, the ROM 47, the server 53, the database 64, and/or the API 76. The API (application programming interface) 76 may comprise, for example, a server (e.g. a real server, or a virtual machine, or a machine running in a cloud infrastructure as a service), or multiple servers networked together, exposing at least one API to client(s) accessing it. These servers may include components such as application servers (e.g. software servers), depending upon what other components are included, such as a caching layer, or database layers, or other components. A backend API may, for example, comprise many such applications, each of which communicate with one another using their public APIs. In some embodiments, the API 76 may hold the bulk of the user data and offer the user management capabilities, leaving the clients to have very limited state.

In some embodiments, user gestures may only be accepted as inputs when performed by an authorized user. Some of the present embodiments, therefore, may comprise automatic identification and data capture (AIDC) and/or computer vision for one or more aspects, such as recognizing authorized user(s). AIDC and computer vision are each described in turn below.

AIDC refers to methods of automatically identifying objects, collecting data about them, and entering that data directly into computer systems (e.g., without human involvement). Technologies typically considered part of AIDC include barcodes, matrix codes, bokodes, radio-frequency identification (RFID), biometrics (e.g. iris recognition, facial recognition, voice recognition, etc.), magnetic stripes, Optical Character Recognition (OCR), and smart cards. AIDC is also commonly referred to as “Automatic Identification,” “Auto-ID,” and “Automatic Data Capture.”

AIDC encompasses obtaining external data, particularly through analysis of images and/or sounds. To capture data, a transducer may convert an image or a sound into a digital file. The file is then typically stored and analyzed by a computer, and/or compared with other files in a database, to verify identity and/or to provide authorization to enter a secured system. In biometric security systems, capture may refer to the acquisition of and/or the process of acquiring and identifying characteristics, such as finger images, palm images, facial images, or iris prints, which all may involve video data, or voice prints, which may involve audio data. Any of these identifying characteristics may be used in the present embodiments to distinguish authorized users from unauthorized users.

RFID uses electromagnetic fields to automatically identify tags, which may be attached to objects. The tags contain electronically stored information, and may be passive or active. Passive tags collect energy from a nearby RFID reader's interrogating radio waves. Active tags have a local power source, such as a battery, and may operate at hundreds of meters from the RFID reader. Unlike a barcode, the tag need not be within the line of sight of the reader, so it may be embedded in the object to which it is attached.

The wireless communication doorbell 61 may capture information embedded in one of these types (or any other type) of AIDC technologies in order to distinguish between authorized persons and unauthorized persons. For example, with reference to FIG. 12, the wireless communication doorbell 61 may include an AIDC module 72 operatively connected to the microcontroller 22. The AIDC module 72 may include hardware and/or software configured for one or more types of AIDC, including, but not limited to, any of the types of AIDC described herein. For example, the AIDC module 72 may include a finger image reader, a palm image reader, a facial image reader, an iris print reader, and/or a voice print reader.

In another example, the AIDC module 72 may include an RFID reader (not shown), which may read an RFID tag carried by an authorized person, such as on, or embedded within, a fob or a keychain. When the wireless communication doorbell 61 detects a person, such as with the infrared sensor 49 and/or the camera 18, the RFID reader may scan the area about the wireless communication doorbell 61 for an RFID tag. If the RFID reader locates an RFID tag associated with an authorized person, then the wireless communication doorbell 61 may accept user gestures from that authorized person, but if the RFID reader does not locate an RFID tag, or locates an RFID tag, but that tag is not associated with an authorized person, then the wireless communication doorbell 61 may not accept user gestures from the person. In some embodiments, the microcontroller 22 of the wireless communication doorbell 61 may be considered to be part of the AIDC module 72 and/or the microcontroller 22 may operate in conjunction with the AIDC module 72 in various AIDC processes. Also in some embodiments, the microphone 21 and/or the camera 18 may be components of the computer vision module 74.

Computer vision includes methods for acquiring, processing, analyzing, and understanding images and, in general, high-dimensional data from the real world in order to produce numerical or symbolic information, e.g. in the form of decisions. Computer vision seeks to duplicate the abilities of human vision by electronically perceiving and understanding an image. Understanding in this context means the transformation of visual images (the input of the retina) into descriptions of the world that can interface with other thought processes and elicit appropriate action. This image understanding can be seen as the disentangling of symbolic information from image data using models constructed with the aid of geometry, physics, statistics, and learning theory. Computer vision has also been described as the enterprise of automating and integrating a wide range of processes and representations for vision perception. As a scientific discipline, computer vision is concerned with the theory behind artificial systems that extract information from images. The image data can take many forms, such as video sequences, views from multiple cameras, or multi-dimensional data from a scanner. As a technological discipline, computer vision seeks to apply its theories and models for the construction of computer vision systems.

One aspect of computer vision comprises determining whether or not the image data contains some specific object, feature, or activity. Different varieties of computer vision recognition include: Object Recognition (also called object classification)—One or several pre-specified or learned objects or object classes can be recognized, usually together with their 2D positions in the image or 3D poses in the scene. Identification—An individual instance of an object is recognized. Examples include identification of a specific person's face or fingerprint, identification of handwritten digits, or identification of a specific vehicle. Detection—The image data are scanned for a specific condition. Examples include detection of possible abnormal cells or tissues in medical images or detection of a vehicle in an automatic road toll system. Detection based on relatively simple and fast computations is sometimes used for finding smaller regions of interesting image data that can be further analyzed by more computationally demanding techniques to produce a correct interpretation.

Several specialized tasks based on computer vision recognition exist, such as: Optical Character Recognition (OCR)—Identifying characters in images of printed or handwritten text, usually with a view to encoding the text in a format more amenable to editing or indexing (e.g. ASCII). 2D Code Reading—Reading of 2D codes such as data matrix and QR codes. Facial Recognition. Shape Recognition Technology (SRT)—Differentiating human beings (e.g. head and shoulder patterns) from objects.

Typical functions and components (e.g. hardware) found in many computer vision systems are described in the following paragraphs. The present embodiments may include at least some of these aspects, and the wireless communication doorbell 61 may capture information using one of these types (or any other type) of computer vision technologies in order to distinguish between authorized persons and unauthorized persons. For example, with reference to FIG. 12, embodiments of the present wireless communication doorbell 61 may include a computer vision module 74. The computer vision module 74 may include any of the components (e.g. hardware) and/or functionality described herein with respect to computer vision, including, without limitation, one or more cameras, sensors, and/or processors. In some embodiments, the microphone 21, the camera 18, and/or the microcontroller 22 may be components of the computer vision module 74.

Image acquisition—A digital image is produced by one or several image sensors, which, besides various types of light-sensitive cameras, may include range sensors, tomography devices, radar, ultra-sonic cameras, etc. Depending on the type of sensor, the resulting image data may be a 2D image, a 3D volume, or an image sequence. The pixel values may correspond to light intensity in one or several spectral bands (gray images or color images), but can also be related to various physical measures, such as depth, absorption or reflectance of sonic or electromagnetic waves, or nuclear magnetic resonance.

Pre-processing—Before a computer vision method is applied to image data in order to extract some specific piece of information, it is usually beneficial to process the data in order to assure that it satisfies certain assumptions implied by the method. Examples of pre-processing include, but are not limited to re-sampling in order to assure that the image coordinate system is correct, noise reduction in order to assure that sensor noise does not introduce false information, contrast enhancement to assure that relevant information can be detected, and scale space representation to enhance image structures at locally appropriate scales.

Feature extraction—Image features at various levels of complexity are extracted from the image data. Typical examples of such features are: Lines, edges, and ridges; Localized interest points such as corners, blobs, or points; More complex features may be related to texture, shape, or motion.

Detection/segmentation—At some point in the processing a decision may be made about which image points or regions of the image are relevant for further processing. Examples are: Selection of a specific set of interest points; Segmentation of one or multiple image regions that contain a specific object of interest; Segmentation of the image into nested scene architecture comprising foreground, object groups, single objects, or salient object parts (also referred to as spatial-taxon scene hierarchy).

High-level processing—At this step, the input may be a small set of data, for example a set of points or an image region that is assumed to contain a specific object. The remaining processing may comprise, for example: Verification that the data satisfy model-based and application-specific assumptions; Estimation of application-specific parameters, such as object pose or object size; Image recognition—classifying a detected object into different categories; Image registration—comparing and combining two different views of the same object.

Decision making—Making the final decision required for the application, for example match/no-match in recognition applications.

One or more of the present embodiments may include a vision processing unit (not shown separately, but may be a component of the computer vision module 74). A vision processing unit is an emerging class of microprocessor; it is a specific type of AI (artificial intelligence) accelerator designed to accelerate machine vision tasks. Vision processing units are distinct from video processing units (which are specialized for video encoding and decoding) in their suitability for running machine vision algorithms such as convolutional neural networks, SIFT, etc. Vision processing units may include direct interfaces to take data from cameras (bypassing any off-chip buffers), and may have a greater emphasis on on-chip dataflow between many parallel execution units with scratchpad memory, like a manycore DSP (digital signal processor). But, like video processing units, vision processing units may have a focus on low precision fixed point arithmetic for image processing.

AIDC and computer vision have significant overlap, and use of either one of these terms herein should be construed as also encompassing the subject matter of the other one of these terms. For example, the AIDC module 72 and the computer vision module 74 may comprise overlapping hardware components and/or functionality. In some embodiments, the AIDC module 72 and the computer vision module 74 may be combined into a single module.

As described above, a user gesture may comprise a visitor 63 making motions with his/her hands within the field of view of the camera 18. A user gesture may also comprise a visitor 63 making a facial expression within the field of view of the camera 18. For example, the visitor 63 may use one or more elements of sign language, such as, but not limited to, hand shapes, orientation and movement of the hands, arms or body, and/or facial expressions.

In some embodiments, the gesture recognition module 70 may be programmable by the user. For example, the user may demonstrate one or more gestures before the camera 18, and the demonstrated gesture(s) may be recorded and stored as gesture data. The user may further associate each demonstrated gesture with a command that is to be executed when an authorized user performs the demonstrated gesture. In one aspect, programming the gesture recognition module 70 may comprise the user associating each demonstrated gesture with a command via the application 55 executing on the smart device 54.

In some embodiments, the wireless communication doorbell 61 may be configured to perform one or more functions based on one or more conditions. One condition may comprise whether one or more persons are present on the premises when another person arrives. If one or more persons are present when another person arrives, the wireless communication doorbell 61 may execute one or more actions, such as sending a notification to at least one of the person(s) present on the premises informing them that the another person has arrived.

For example, in one aspect the wireless communication doorbell 61 may store information in a memory (e.g., a local memory or a remote memory) about one or more persons who are present at the premises. This information may be used (e.g., in conjunction with gesture recognition, facial recognition, and/or another type of AIDC or computer vision) to send a message to at least one of the persons present at the premises. The message may comprise a notification that another person has arrived and may, in some embodiments, contain information about the identity of the another person who has arrived at the premises. For example, a first person may be present at the premises, and a second person, such as the spouse or roommate of the first person, arrives. The wireless communication doorbell 61 may recognize the second person, for example through facial recognition, and send a message to the first person that the second person has arrived. In some embodiments, the message may indicate the identity of the second person. The message may, in some embodiments, be text-based or audio, and may be sent to a mobile device associated with the first person and/or to an e-mail address associated with the first person. Alternatively, or in addition, the message may be sent to a device at a fixed location, such as in a particular room inside the premises. In one aspect, the premises may include one or more such fixed-location devices, and each may comprise a speaker. When the second person arrives, an announcement may be played through the speaker of the one or more fixed-location devices informing the first person that the second person has arrived. In some embodiments, the location of the first person within the premises may be known, and the announcement may be played through the speaker of only one of the fixed-location devices, such as whichever one of the fixed-location devices is in the same room as the first person (or nearest the location of the first person). In such embodiments, the location of the first person within the premises may be known through one or more cameras within the premises. For example, the cameras may be components of the fixed-location devices within the premises. Alternatively, or in addition, another type of AIDC or computer vision, such as RFID, may be used to determine the location of the first person within the premises. For example, an RFID tag associated with the first person may be detected in a particular room within the premises, and the location of the first person may be determined to correspond to the location of the detected RFID tag.

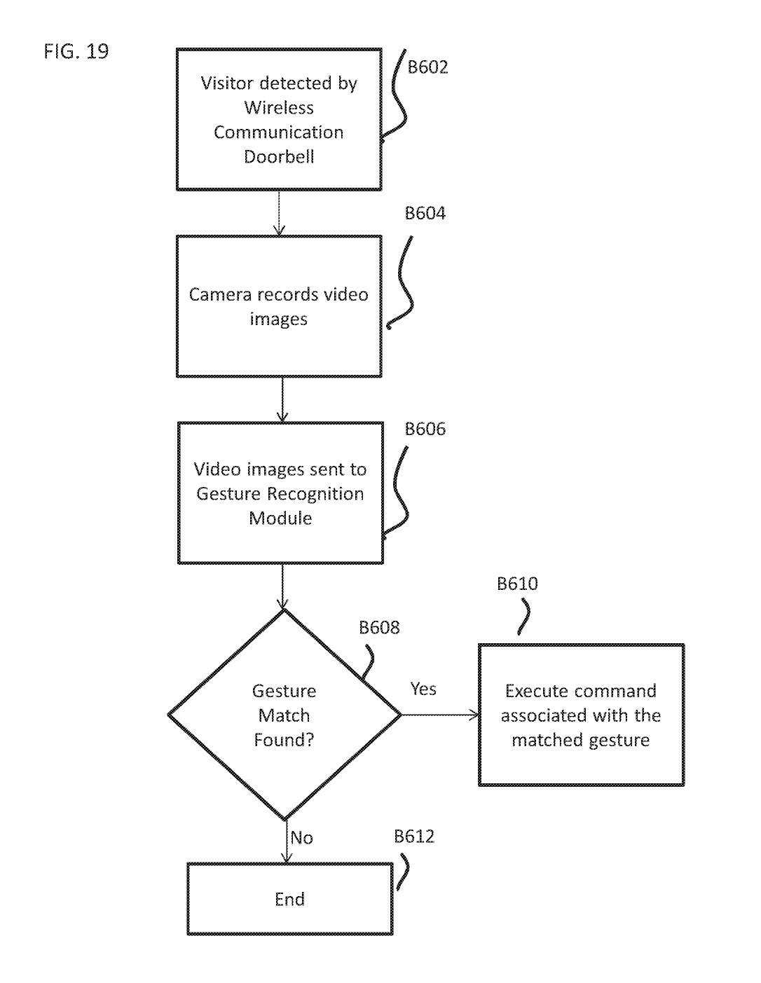

FIG. 19 is a flowchart illustrating a process for using a wireless audio/video (A/V) recording and communication device for gesture recognition according to various aspects of the present disclosure. The process described with reference to FIG. 19, as well as all process described herein, may be implemented in software, firmware, or hardware, or in any combination of software, firmware, and hardware. For example, in some implementations the process described with reference to FIG. 19 may be embodied in software executed by the microcontroller 22, the gesture recognition module 70, the AIDC module 72, or the computer vision module 74, or by any combination of the microcontroller 22, the gesture recognition module 70, the AIDC module 72, and the computer vision module 74. For consistency with the description of the other aspects of the present disclosure, the person at the door may be referred to as a visitor 63, although such person may be an owner or an occupant of the premises rather than a visitor.

With reference to FIG. 19, at block B602 the wireless communication doorbell 61 detects a visitor 63. In one aspect, detecting the visitor 63 may comprise the visitor 63 pushing the button 11 located on the front face of the wireless communication doorbell 61. In another aspect, detecting the visitor 63 may comprise the wireless communication doorbell 61 detecting motion with either or both of the camera 18 and the infrared sensor 49. Detecting the visitor 63 may trigger the camera 18 to record video images of the visitor 63, as shown at block B604.

At block B606, the video images of the visitor 63 may be sent to and processed by the gesture recognition module 70. In one aspect, the gesture recognition module 70 may identify user gestures based at least in part upon the motion and/or position of the hands of the visitor 63. For example, the gesture recognition module 70 may execute an algorithm to analyze the relative positions of the visitor's hands and/or a sequence of movements of the visitor's hands. These aspects may then be compared with the gesture data to determine whether there is a match, as shown at block B608.

If a gesture match is found, then the process moves to block B610 where the command associated with the matched gesture is executed. As discussed above, commands or actions that may be executed may include, without limitation, unlocking a door (such as the front entrance door), disarming a security system, beginning an intercom session, transmitting a prerecorded audio message, playing an audio message via the speaker 20, or sending a text-based (e.g., SMS or e-mail) message to a phone number or an e-mail address. After the command associated with the matched gesture is executed at block B610, the process ends at block B612. And, if no gesture match is found at block B608, the process ends at block B612.

As described above, the present embodiments advantageously improve the functionality of A/V recording and communication devices. For example, the present embodiments enable such devices to be used for various tasks based on user gestures recorded by the camera of the A/V recording and communication device, thereby eliminating any need to use a traditional input device, such as a keypad, which is cumbersome and can be hacked or otherwise compromised. Non-limiting examples of tasks that can be accomplished with user gestures include, but are not limited to, gaining access to the home (or other structure associated with the A/V recording and communication device), executing tasks within the home, and notifying person(s) within the home of a person's arrival.

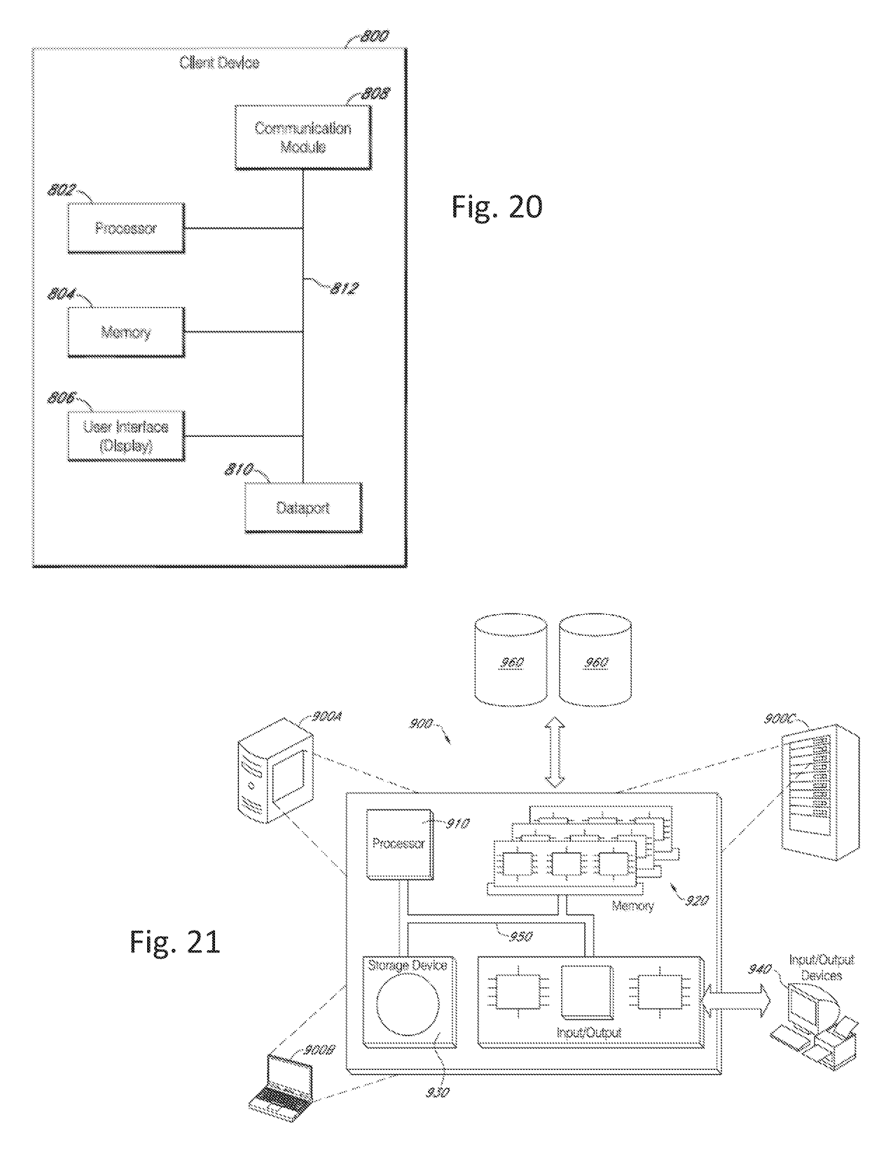

FIG. 20 is a functional block diagram of a client device 800 on which the present embodiments may be implemented according to various aspects of the present disclosure. The user's client device 114 described with reference to FIG. 1 may include some or all of the components and/or functionality of the client device 800. The client device 800 may comprise, for example, a smartphone.

With reference to FIG. 20, the client device 800 includes a processor 802, a memory 804, a user interface 806, a communication module 808, and a dataport 810. These components are communicatively coupled together by an interconnect bus 812. The processor 802 may include any processor used in smartphones and/or portable computing devices, such as an ARM processor (a processor based on the RISC (reduced instruction set computer) architecture developed by Advanced RISC Machines (ARM).). In some embodiments, the processor 802 may include one or more other processors, such as one or more conventional microprocessors, and/or one or more supplementary co-processors, such as math co-processors.

The memory 804 may include both operating memory, such as random access memory (RAM), as well as data storage, such as read-only memory (ROM), hard drives, flash memory, or any other suitable memory/storage element. The memory 804 may include removable memory elements, such as a CompactFlash card, a MultiMediaCard (MMC), and/or a Secure Digital (SD) card. In some embodiments, the memory 804 may comprise a combination of magnetic, optical, and/or semiconductor memory, and may include, for example, RAM, ROM, flash drive, and/or a hard disk or drive. The processor 802 and the memory 804 each may be, for example, located entirely within a single device, or may be connected to each other by a communication medium, such as a USB port, a serial port cable, a coaxial cable, an Ethernet-type cable, a telephone line, a radio frequency transceiver, or other similar wireless or wired medium or combination of the foregoing. For example, the processor 802 may be connected to the memory 804 via the dataport 810.

The user interface 806 may include any user interface or presentation elements suitable for a smartphone and/or a portable computing device, such as a keypad, a display screen, a touchscreen, a microphone, and a speaker. The communication module 808 is configured to handle communication links between the client device 800 and other, external devices or receivers, and to route incoming/outgoing data appropriately. For example, inbound data from the dataport 810 may be routed through the communication module 808 before being directed to the processor 802, and outbound data from the processor 802 may be routed through the communication module 808 before being directed to the dataport 810. The communication module 808 may include one or more transceiver modules capable of transmitting and receiving data, and using, for example, one or more protocols and/or technologies, such as GSM, UMTS (3GSM), IS-95 (CDMA one), IS-2000 (CDMA 2000), LTE, FDMA, TDMA, W-CDMA, CDMA, OFDMA, Wi-Fi, WiMAX, or any other protocol and/or technology.

The dataport 810 may be any type of connector used for physically interfacing with a smartphone and/or a portable computing device, such as a mini-USB port or an IPHONE®/IPOD® 30-pin connector or LIGHTNING® connector. In other embodiments, the dataport 810 may include multiple communication channels for simultaneous communication with, for example, other processors, servers, and/or client terminals.

The memory 804 may store instructions for communicating with other systems, such as a computer. The memory 804 may store, for example, a program (e.g., computer program code) adapted to direct the processor 802 in accordance with the present embodiments. The instructions also may include program elements, such as an operating system. While execution of sequences of instructions in the program causes the processor 802 to perform the process steps described herein, hard-wired circuitry may be used in place of, or in combination with, software/firmware instructions for implementation of the processes of the present embodiments. Thus, the present embodiments are not limited to any specific combination of hardware and software.

FIG. 21 is a functional block diagram of a general-purpose computing system on which the present embodiments may be implemented according to various aspects of the present disclosure. The computer system 900 may be embodied in at least one of a personal computer (also referred to as a desktop computer) 900A, a portable computer (also referred to as a laptop or notebook computer) 900B, and/or a server 900C. A server is a computer program and/or a machine that waits for requests from other machines or software (clients) and responds to them. A server typically processes data. The purpose of a server is to share data and/or hardware and/or software resources among clients. This architecture is called the clien—tserver model. The clients may run on the same computer or may connect to the server over a network. Examples of computing servers include database servers, file servers, mail servers, print servers, web servers, game servers, and application servers. The term server may be construed broadly to include any computerized process that shares a resource to one or more client processes.

The computer system 900 may execute at least some of the operations described above. The computer system 900 may include at least one processor 910, memory 920, at least one storage device 930, and input/output (I/O) devices 940. Some or all of the components 910, 920, 930, 940 may be interconnected via a system bus 950. The processor 910 may be single- or multi-threaded and may have one or more cores. The processor 910 may execute instructions, such as those stored in the memory 920 and/or in the storage device 930. Information may be received and output using one or more I/O devices 940.

The memory 920 may store information, and may be a computer-readable medium, such as volatile or non-volatile memory. The storage device(s) 930 may provide storage for the system 900, and may be a computer-readable medium. In various aspects, the storage device(s) 930 may be a flash memory device, a hard disk device, an optical disk device, a tape device, or any other type of storage device.

The I/O devices 940 may provide input/output operations for the system 900. The I/O devices 940 may include a keyboard, a pointing device, and/or a microphone. The I/O devices 940 may further include a display unit for displaying graphical user interfaces, a speaker, and/or a printer. External data may be stored in one or more accessible external databases 960.

The features described may be implemented in digital electronic circuitry, or in computer hardware, firmware, software, or in combinations thereof. The apparatus may be implemented in a computer program product tangibly embodied in an information carrier, e.g., in a machine-readable storage device or in a propagated signal, for execution by a programmable processor; and method steps may be performed by a programmable processor executing a program of instructions to perform functions of the described implementations by operating on input data and generating output.

The described features may be implemented in one or more computer programs that are executable on a programmable system including at least one programmable processor coupled to receive data and instructions from, and to transmit data and instructions to, a data storage system, at least one input device, and at least one output device. A computer program may include set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors of any kind of computer. Generally, a processor may receive instructions and data from a read only memory or a random access memory or both. Such a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable, disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks may include, e.g., a LAN, a WAN, and the computers and networks forming the Internet.

The computer system may include clients and servers. A client and server may be remote from each other and interact through a network, such as the described one. The relationship of client and server may arise by virtue of computer programs running on the respective computers and having a client-server relationship to each other.

Numerous additional modifications and variations of the present disclosure are possible in view of the above teachings. It is therefore to be understood that within the scope of the appended claims, the present disclosure may be practiced other than as specifically described herein.

1. A method for a wireless audio/video (A/V) recording and communication device, the device including a processor, a wireless communication module, and a camera, the method comprising:
the camera receiving an input comprising a user-generated gesture, the user-generated gesture including at least one movement made by a user within the field of view of the camera;
the processor processing information about the user-generated gesture and generating an output of interpreted information about the user-generated gesture;
the wireless communication module transmitting the interpreted information about the user-generated gesture to a network device;
the wireless A/V recording and communication device receiving a command from the network device when the interpreted information about the user-generated gesture matches defined gesture information associated with the command; and
the processor executing the command.

2. The method of claim 1, wherein the input further comprises an image of the face of the user.

3. The method of claim 2, wherein the command is to play an audio message containing information relating to the identity of the user within the field of view of the camera.

4. The method of claim 2, wherein the command is based on the identity of the user within the field of view of the camera.

5. The method of claim 4, wherein the command is further based on the identity of at least one person known to be present at a premises associated with the wireless A/V recording and communication device.

6. The method of claim 1, wherein the at least one movement comprises at least one of hand movements or sign language.

7. The method of claim 1, wherein the at least one movement comprises a facial expression.

8. The method of claim 1, wherein the at least one movement comprises displaying a printed key within the field of view of the camera.

9. The method of claim 1, wherein the interpreted information comprises information about relative geometric locations of the user's hand in a plane within the field of view of the camera.

10. The method of claim 1, wherein the command is to unlock a door lock, or to disarm a security system, or to disable a motion detector, or to activate a light.

11. The method of claim 1, wherein the command is to transmit a message to a second user.

12. The method of claim 11, wherein the message includes information about the user within the field of view of the camera.

13. The method of claim 1, wherein the command is to play an audio message.

14. The method of claim 13, wherein the audio message indicates the received command has been executed.

15. A method for a network device including a processor and a memory, the method comprising:
receiving, from a wireless audio/video (A/V) recording and communication device, interpreted information about a user-generated gesture, the user-generated gesture including at least one movement made by a user within the field of view of a camera of the wireless A/V recording and communication device;
the processor comparing the interpreted information with defined gesture information stored in the memory, and, when the interpreted information matches the defined gesture information, determining a command associated with the defined gesture information; and
transmitting the command to the wireless A/V recording and communication device.

16. The method of claim 15, wherein the input further comprises an image of the face of the user.

17. The method of claim 16, wherein the command is to play an audio message containing information relating to the identity of the user within the field of view of the camera.

18. The method of claim 16, wherein the command is based on the identity of the user within the field of view of the camera.

19. The method of claim 18, wherein the command is further based on the identity of at least one person known to be present at a premises associated with the wireless A/V recording and communication device.

20. The method of claim 15, wherein the at least one movement comprises at least one of hand movements or sign language.

21. The method of claim 15, wherein the at least one movement comprises a facial expression.

22. The method of claim 15, wherein the at least one movement comprises displaying a printed key within the field of view of the camera.

23. The method of claim 15, wherein the interpreted information comprises information about relative geometric locations of the user's hand in a plane within the field of view of the camera.

24. The method of claim 15, wherein the command is to unlock a door lock, or to disarm a security system, or to disable a motion detector, or to activate a light.

25. The method of claim 15, wherein the command is to transmit a message to a second user.

26. The method of claim 25, wherein the message includes information about the user within the field of view of the camera.

27. The method of claim 15, wherein the command is to play an audio message.

28. The method of claim 27, wherein the audio message indicates the received command has been executed.

29. A method for a wireless audio/video (A/V) recording and communication device, the device including a processor, a memory, and a camera, the method comprising:
the camera receiving an input comprising a user-generated gesture, the user-generated gesture including at least one movement made by a user within the field of view of the camera;
the processor processing information about the user-generated gesture and generating interpreted information about the user-generated gesture;
the processor comparing the interpreted information about the user-generated gesture with defined gesture information stored in the memory, and, when the interpreted information matches the defined gesture information, determining a command associated with the defined gesture information; and
the processor executing the command.

30. The method of claim 29, wherein the input further comprises an image of the face of the user.

31. The method of claim 30, wherein the command is to play an audio message containing information relating to the identity of the user within the field of view of the camera.

32. The method of claim 30, wherein the command is based on the identity of the user within the field of view of the camera.

33. The method of claim 32, wherein the command is further based on the identity of at least one person known to be present at a premises associated with the wireless A/V recording and communication device.

34. The method of claim 29, wherein the at least one movement comprises at least one of hand movements or sign language.

35. The method of claim 29, wherein the at least one movement comprises a facial expression.

36. The method of claim 29, wherein the at least one movement comprises displaying a printed key within the field of view of the camera.

37. The method of claim 29, wherein the interpreted information comprises information about relative geometric locations of the user's hand in a plane within the field of view of the camera.

38. The method of claim 29, wherein the command is to unlock a door lock, or to disarm a security system, or to disable a motion detector, or to activate a light.

39. The method of claim 29, wherein the command is to transmit a message to a second user.

40. The method of claim 39, wherein the message includes information about the user within the field of view of the camera.

41. The method of claim 29, wherein the command is to play an audio message.

42. The method of claim 41, wherein the audio message indicates the received command has been executed.
